(19) United States
(12) Patent Application Publication
(10) Pub. No.: US 2026/0357633 A1
(43) Pub. Date: Nov. 12, 2026

(54) DOOR DRIVING MODULE AND HOME APPLIANCE INCLUDING THE SAME

(71) Applicant: SAMSUNG ELECTRONICS CO., LTD., Suwon-si (KR)

(72) Inventors: Jihong KIM, Suwon-si (KR); Semin LEE, Suwon-si (KR); Geonhee LEE, Suwon-si (KR); Hyunuk PARK, Suwon-si (KR); Elijah KIM, Suwon-si (KR)

(73) Assignee: SAMSUNG ELECTRONICS CO., LTD., Suwon-si (KR)

(21) Appl. No.: 19/691,191

(22) Filed: May 28, 2026

Related U.S. Application Data
(63) Continuation of application No. PCT/KR2026/096342, filed on Apr. 27, 2026.

(30) Foreign Application Priority Data
May 12, 2025 (KR) 10-2025-0060864
Nov. 26, 2025 (KR) 10-2025-0182698

(51) Int. Cl. E05F 15/622

(52) U.S. Cl. CPC E05F 15/622; E05Y 2900/308

(57) ABSTRACT

A home appliance includes a main body, a door, and a door driving module configured to open or close the door. The door driving module includes a driving motor, a transmission, a bushing configured such that rotational force is transmitted to the transmission, and the transmission is movable, a transfer block configured to move based on an opening or closing operation, a first spindle configured to guide movement of the transfer block such that the first spindle rotates based on the opening or closing operation, and a second spindle configured to guide the movement of the transmission such that the second and first spindle rotate. In the automatic mode, the transmission is configured to transfer the rotational force to the second spindle. In the manual mode, the transmission is configured to move within the space of the bushing based on the rotational force from the second spindle.

### CROSS-REFERENCE TO RELATED APPLICATIONS

This application is a continuation application, claiming priority under 35 U.S.C. §111(a), of International Application No. PCT/KR2026/096342, filed on Apr. 27, 2026, which claims priority under 35 U.S.C. §119 to Korean Patent Application No. 10-2025-0060864, filed on May. 12, 2025, and Korean Patent Application No. 10-2025-0182698, filed on Nov. 26, 2025, in the Ministry of Intellectual Property, the disclosure of which is incorporated by reference herein their entireties.

### TECHNICAL FIELD

An embodiment of the disclosure relates to a home appliance including a door driving module.

### BACKGROUND ART

Home appliances refer to electronic and electrical devices used in the home, and may include devices, such as refrigerators, washers, and air conditioners that help make household chores more convenient and enhance the quality of life.

A cooking device is a home appliance provided in a kitchen and is used to cook food. The cooking device may include, e.g., an oven and/or a cooktop.

The oven may be disposed at a lower portion of the cooking device. The oven is a device that heats and cooks food in a cooking chamber provided therein. The oven may be classified into an electric type, a gas type, and an electronic type according to a heating method (or a heat source). For example, an electric oven uses an electric heater as a heat source, and a gas oven and a microwave oven use heat from gas and frictional heat of water molecules caused by high frequency as a heat source, respectively.

The cooktop may be disposed at an upper portion of the cooking device (e.g., an upper portion of the oven). The cooktop may heat food using an induction heating device (e.g., an induction device) as a heat source, and a ceramic glass may be disposed on an upper surface of the cooktop.

The cooking device may include a door opening or closing a cooking chamber and a hinge rotatably coupling the door to the cooking device.

The above-described information may be provided as related art for the purpose of helping understanding of the disclosure. No claim or determination is made as to whether any of the foregoing is applicable as background art in relation to the disclosure.

### DISCLOSURE OF INVENTION

### SOLUTION TO PROBLEMS

A home appliance according to an embodiment of the disclosure may include a main body having an open front, a door rotatably connected to the main body, and a door driving module configured to open or close the door in an automatic mode or a manual mode with respect to the main body. The door driving module may include a driving motor, a transmission, a bushing coupled with the driving motor and the transmission such that the rotational force generated from the driving motor is transmitted to the transmission, the busing defining space in which the transmission is movable along a front-rear direction of the door driving module, a transfer block configured to move along the front-rear direction based on an opening operation or a closing operation of the door in the automatic mode or the manual mode, a first spindle configured to guide a movement of the transfer block along the front-rear direction and to rotate based on the opening operation or the closing operation of the door, and a second spindle configured to guide a movement of the transmission along the front-rear direction such that the second spindle, having a front end coupled to the first spindle, rotates in conjunction with the rotation of the first spindle. In the automatic mode of the door, the transmission may be configured to transfer the rotational force received from the driving motor to the second spindle. In the manual mode of the door, the transmission may be configured to move along the front-rear direction within the space of the bushing based on the rotational force received from the second spindle.

A door driving module according to an embodiment of the disclosure may include a driving motor, a transmission, a bushing coupled with the driving motor and the transmission such that the rotational force generated from the driving motor is transmitted to the transmission, the busing defining a space in which the transmission is movable along a front-rear direction of the door driving module, a transfer block configured to move in the front-rear direction in response to an opening operation or a closing operation of the door in the automatic mode or the manual mode, a transfer block configured to move along the front-rear direction based on an opening operation or a closing operation of the door in the automatic mode or the manual mode, a first spindle configured to guide movement of the transfer block along the front-rear direction such that the first spindle rotates based on the opening operation or the closing operation of the door, and a second spindle configured to guide a movement of the transmission along the front-rear direction such that the second spindle, having a front end thereof coupled to the first spindle, rotates in conjunction with the rotation of the first spindle. In the automatic mode of the door, the transmission may be configured to transfer the rotational force generated from the driving motor to the second spindle. In the manual mode of the door, the transmission may be configured to move along the front-rear direction within the space of the bushing based on the rotational force received from the second spindle.

However, the problems to be solved by the disclosure are not limited to the above-mentioned problems and may be variously determined without departing from the spirit and scope of the disclosure.

### BRIEF DESCRIPTION OF DRAWINGS

FIG. 1 is a perspective view illustrating a home appliance according to an embodiment of the disclosure.

FIG. 2 is a view illustrating a state in which a door of a home appliance is opened according to an embodiment of the disclosure.

FIG. 3 is a side cross-sectional view illustrating a home appliance according to an embodiment of the disclosure.

FIG. 4 is a perspective view illustrating a main body, a door, a hinge module, and a door driving module of a home appliance according to an embodiment of the disclosure.

FIG. 5 is a perspective view illustrating a door driving module in a transparent manner, according to an embodiment of the disclosure.

FIG. 6 is a view illustrating an associated configuration of internal components of a door driving module in a transparent manner, according to an embodiment of the disclosure.

FIG. 7 is a cross-sectional view disclosing an associated configuration of internal components of a door driving module according to an embodiment of the disclosure.

FIG. 8 is a block diagram illustrating a home appliance according to an embodiment of the disclosure.

FIGS. 9A and 9B are views illustrating an opening operation of a door in a manual mode according to an embodiment of the disclosure.

FIGS. 10A and 10B are views illustrating a closing operation of a door in a manual mode according to an embodiment of the disclosure.

FIGS. 11A-11C are views illustrating an opening operation of a door in an automatic mode according to an embodiment of the disclosure.

FIGS. 12A-12C are views illustrating a closing operation of a door in an automatic mode according to an embodiment of the disclosure.

FIG. 13 is a cross-sectional view disclosing an associated configuration of internal components of a door driving module according to an embodiment of the disclosure.

FIGS. 14A and 14B are views illustrating states of a door driving module related to the manual and automatic modes of a door and the open and closed states of the door according to an embodiment of the disclosure.

FIG. 15 is a perspective view illustrating a door driving module, a hinge module, and a circuit board disposed in a home appliance according to an embodiment of the disclosure.

FIG. 16 is a view illustrating a door driving module, a hinge module, and a circuit board in a transparent manner, according to an embodiment of the disclosure.

FIG. 17 is a view illustrating a home appliance disposed in a furniture cabinet and an outdoor air circulation structure according to an embodiment of the disclosure.

FIG. 18 is a perspective view illustrating outdoor air circulating through a blower device of a home appliance according to an embodiment of the disclosure.

FIG. 19 is a perspective view illustrating an outdoor air circulation structure around a circuit board of a home appliance according to an embodiment of the disclosure.

FIG. 20 is a view illustrating an insulating cover and a circuit board in a home appliance according to an embodiment of the disclosure.

FIG. 21 is a view illustrating a cross-section of an insulating cover and a circuit board in a home appliance according to an embodiment of the disclosure.

In the following description, attached drawings are referred to, and specific examples that may be implemented are illustrated in the drawings. Other examples may be utilized and structural changes may be made without departing from the scope of the various examples.

### MODE FOR THE INVENTION

It should be appreciated that various embodiments of the present disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases.

The term "and/or" includes a combination of a plurality of related listed components or any one of the plurality of related listed components.

As used herein, such terms as "1st" and "2nd," or “first” and "second" may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element.

Terms such as "comprise" or "have" are intended to designate that features, numbers, steps, operations, components, portions, or combinations thereof described in this document exist, and do not preclude the presence or addition of one or more other features, numbers, steps, operations, components, portions, or combinations thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned "on" another component, the first component may be positioned directly on the second component, or other component(s) may be positioned between the first and second component.

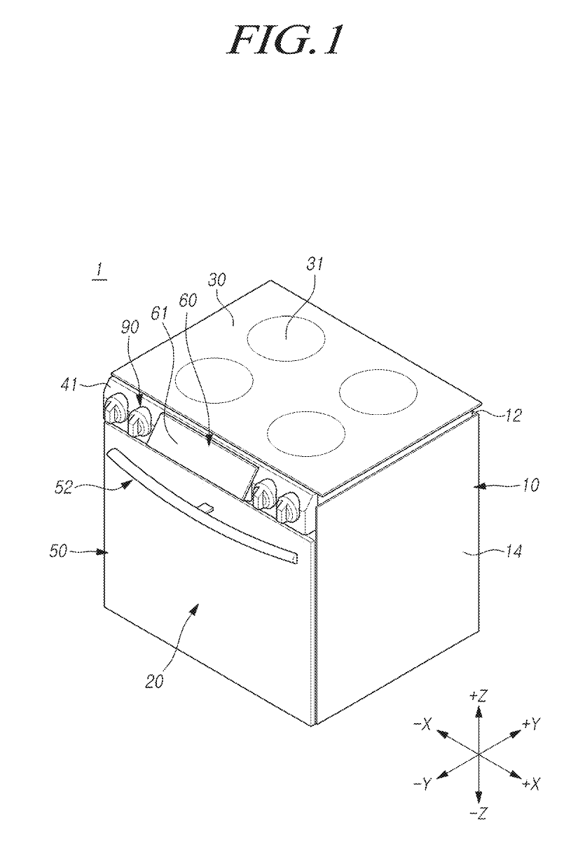

FIG. 1 is a perspective view illustrating a home appliance according to an embodiment of the disclosure.

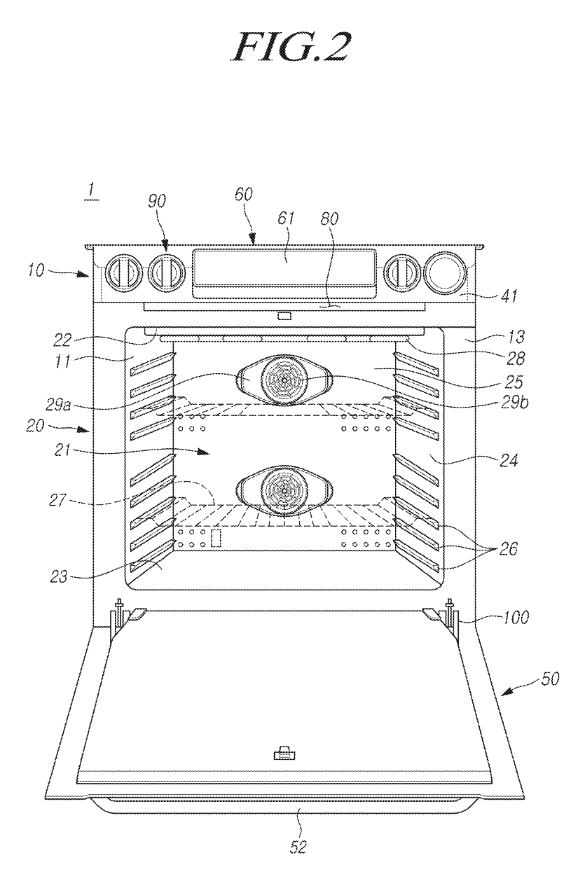

FIG. 2 is a view illustrating a state in which a door of a home appliance is opened according to an embodiment of the disclosure.

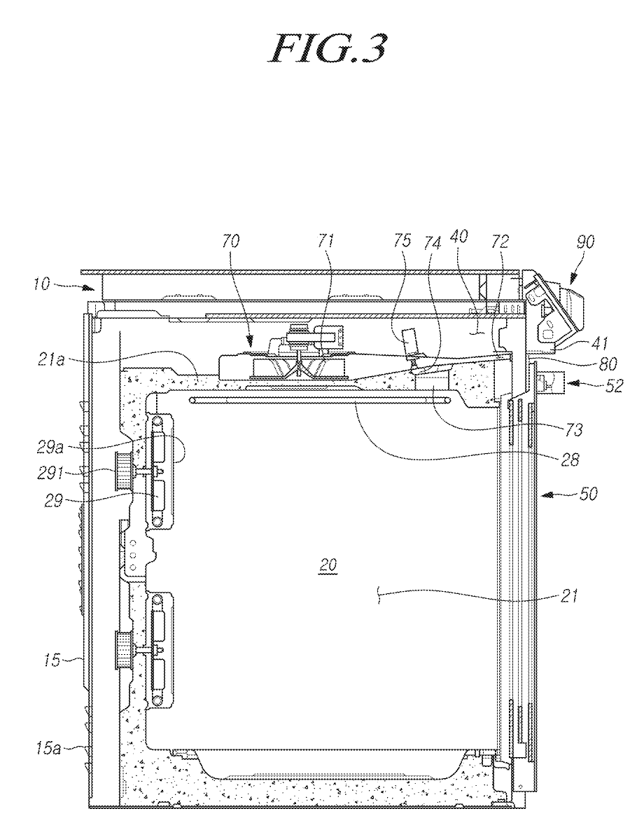

FIG. 3 is a side cross-sectional view illustrating a home appliance according to an embodiment of the disclosure.

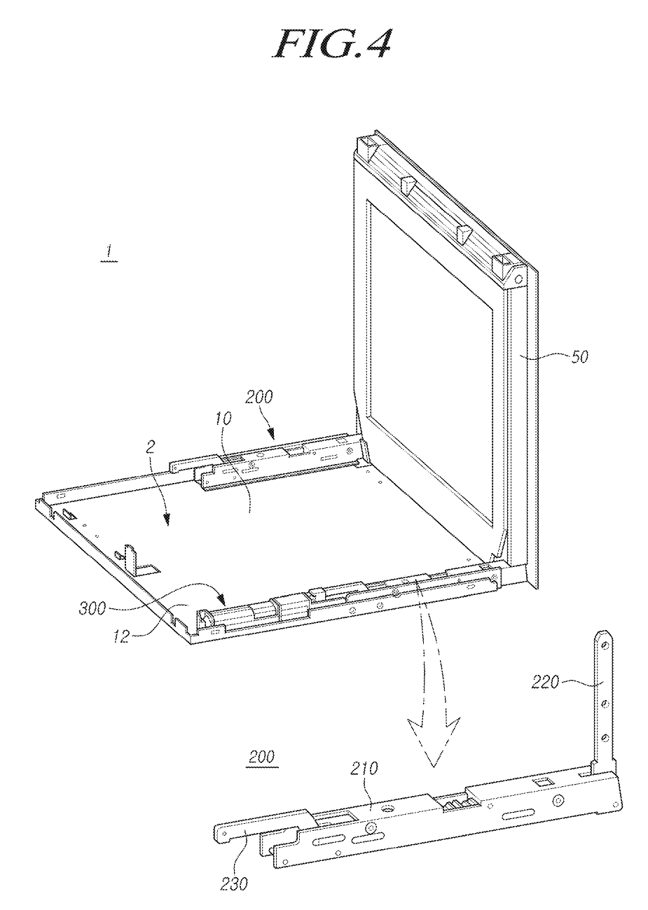

The configurations of the embodiments of FIGS. 1-3 may be identical in whole or portion to the configuration of the embodiments of FIGS. 4-12.

The embodiments of FIGS. 1-3 may be combined with the embodiments of FIGS. 4-12.

Referring to FIGS. 1, 2, and 3, a home appliance 1 is illustrated. Hereinafter, for convenience of description, the home appliance 1 described using FIGS. 1-14B as examples may be described as a cooking device including an oven 20 and a cooktop 30 positioned on an upper portion of the oven 20, but the home appliance 1 of the disclosure is not limited thereto. For example, the home appliance 1 of the disclosure may also be described as a home appliance having a door, such as a dish washer, a refrigerator, or a washer.

The home appliance 1 may include the oven 20 and the cooktop 30 positioned on the upper portion of the oven 20. The home appliance 1 may be a device in which the oven 20 and the cooktop 30 are combined or integrally formed. However, this is an exemplary drawing for description, and the home appliance 1 may include various types of heating devices having a knob assembly 90 on a control panel 41. For example, the home appliance 1 may be interpreted as the oven 20 having the knob assembly 90 mounted thereon. For example, the home appliance 1 may be interpreted as the cooktop 30 having the knob assembly 90 mounted thereon.

According to an embodiment, in the home appliance 1 in which the oven 20 and the cooktop 30 are vertically combined, the oven 20 and the cooktop 30 may have various types of heat source combinations. For example, the cooktop 30 may include an electric or gas heating source. For example, the oven 20 may be an electric or gas type. For example, the heating methods of the cooktop 30 and the oven 20 may be different.

According to an embodiment, the home appliance 1 may include a housing 10. The housing 10 may include an inner case 11 and an outer case 12 coupled to an outer side of the inner case 11. The housing 10 may form at least a portion of an exterior of the home appliance 1.

According to an embodiment, the housing 10 may include a cooking chamber 21 formed inside the housing 10. For example, the inner case 11 of the housing 10 may form the cooking chamber 21 of the oven 20. The outer case 12 of the housing 10 may form an exterior of the home appliance 1. The inner case 11 and the outer case 12 of the housing 10 may each be formed to have an open front.

According to an embodiment, the home appliance 1 may include a cooktop 30 provided on an upper end of the oven 20 for placing and heating a container including food thereon. At least one heating unit 31 may be provided in the cooktop 30. The container containing the food may be positioned on the heating unit 31 to be heated.

According to an embodiment, the home appliance 1 may include the oven 20 provided below the cooktop 30 and including the cooking chamber 21.

According to an embodiment, the home appliance 1 may include a door 50 provided on a front surface of the housing 10 or a front surface of the oven 20 and configured to open or close the cooking chamber 21 of the oven 20. For example, the door 50 may be rotatably coupled to the housing 10 and configured to open or close the cooking chamber 21.

According to an embodiment, the outer case 12 may include a front panel 13 forming a front surface of the housing 10, a side panel 14 forming a side surface of the housing 10, and a rear panel 15 forming a rear surface of the housing 10.

According to an embodiment, the front panel 13 may be provided with an opening, and the opening may open the front of the cooking chamber 21 provided inside the housing 10. A control panel 41 covering the front surface of the electrical component chamber 40 may be provided at an upper portion of the front panel 13.

According to an embodiment, the display module 60 may be mounted on the control panel 41. The display module 60 may include a cover panel 61 provided on a front surface of a display portion. The cover panel 61 may be mounted to protect the display portion of the display module 60, but is not limited thereto, and may also be mounted as a touch panel capable of receiving a touch command from a user.

According to an embodiment, the control panel 41 may be disposed on at least a portion of the housing 10. For example, the control panel 41 may be disposed on an upper side of the housing 10. For example, the control panel 41 may be disposed on a front upper side of the housing 10.

According to an embodiment, an inlet 15a may be provided in the rear panel 15 so that air is sucked into the electrical component chamber 40. Air sucked into the electrical component chamber 40 through the inlet 15a may flow inside the electrical component chamber 40, cooling the electric components disposed in the electrical component chamber 40. The air that has flowed inside the electrical component chamber 40 may be discharged to the front of the home appliance 1 through an outlet 80 along a discharge flow path 72. The outlet 80 may include a space between the front panel 13 and the control panel 41. However, the disclosure is not limited thereto, and the outlet 80 may be provided at various positions to discharge the flowing air inside the electrical component chamber 40. The inlet 15a may be formed at various positions for introducing air into the electrical component chamber 40 as well as the rear panel 15.

According to an embodiment, the oven 20 may include the cooking chamber 21 defined as an inner space of the oven 20 or an inner space of the housing 10. The cooking chamber 21 may be formed by a top plate 22, a bottom plate 23, both side plates 24 disposed to face each other, and a rear plate 25. The cooking chamber 21 is a cooking space, and has the front surface open through the opening of the front panel 13 to allow food to be taken in and out. The cooking chamber 21 may be opened or closed according to a position or operation of the door 50.

According to an embodiment, a plurality of supports 26 may be provided on inner surfaces of the both side plates 24 of the cooking chamber 21. The plurality of supports 26 may be provided to protrude inward from the both side plates 24. At least one detachable rack 27 capable of placing food thereon may be mounted on the plurality of supports 26. For example, the plurality of supports 26 may extend in a horizontal direction to horizontally mount the rack 27. The rack 27 may be defined and/or referred to as a food support plate.

According to an embodiment, a rail (not shown) capable of dividing the cooking chamber 21 into a plurality of sections may be installed on the plurality of supports 26. The user may move the rack 27 through the rail. A divider (not illustrated) dividing the cooking chamber 21 into a plurality of portions may be detachably mounted on the plurality of supports 26. The user may use the space of the cooking chamber 21 divided into a plurality of sections in various manners according to intentions. The divider may be formed of an insulating material to insulate each of the divided spaces.

According to an embodiment, a heater 28 for heating food may be provided in the cooking chamber 21. The heater 28 may be an electric heater including an electric resistor. However, the disclosure is not limited thereto, and the heater 28 may be a gas heater that generates heat by burning a gas.

According to an embodiment, a circulation fan 29 for circulating air in the cooking chamber 21 to heat the food evenly and a circulation motor 291 for driving the circulation fan 29 may be provided on the rear plate 25 of the cooking chamber 21.

According to an embodiment, a fan cover 29a covering the circulation fan 29 may be provided on a front surface of the circulation fan 29, and an outflow hole 29b through which air flows may be formed in the fan cover 29a.

According to an embodiment, the open front surface of the cooking chamber 21 is opened or closed by the door 50, and the door 50 may be coupled to the housing 10 so as to be rotatable relative to the housing 10. For example, the door 50 may be coupled to the housing 10 by a hinge module 100 provided at a lower portion of the housing 10.

According to an embodiment, the hinge module 100 may be coupled or connected to the door 50 and the housing 10 so that the door 50 is relatively rotatable about the housing 10. For example, the door 50 may rotate to close the cooking chamber 21 (e.g., FIG. 1) or rotate to close the cooking chamber 21 (e.g., FIG. 2) through the hinge module 100.

According to an embodiment, a handle 52 grasped by a user to open or close the cooking chamber 21 by the door 50 may be provided on a front upper portion of the door 50.

According to an embodiment, the knob assembly 90 capable of operating the cooktop 30 of the home appliance 1 may be provided on the control panel 41. The knob assembly 90 may be provided in plural according to the number of heating portions 31 to be operated, but the disclosure is not limited thereto.

According to an embodiment, an insulator 21a configured to prevent heat from the cooking chamber 21 from being transferred to the electrical component chamber 40 may be provided between the electrical component chamber 40 and the cooking chamber 21. The insulator 21a may insulate the machine chamber 40 and the cooking chamber 21. The insulator 21a may cover not only between the electrical component chamber 40 and the cooking chamber 21, but also an outer side of the cooking chamber 21 as a whole so that heat from the cooking chamber 21 is not transferred to an outer side of the home appliance 1.

According to an embodiment, since a temperature inside the electrical component chamber 40 may rise due to heat from various electrical components, a blower device 70 capable of cooling the electrical component chamber 40 by circulating air around the electrical component chamber 40 may be provided in the home appliance 1. The blower device 70 may include a blower fan 71 flowing air and the discharge flow path 72 provided to discharge air sucked by the blower fan 71 to the front of the home appliance 1.

According to an embodiment, the blower fan 71 of the blower device 70 may suck air in an axial direction and then discharge the air in a radial direction. As an example, the blower fan 71 may be a centrifugal fan. Alternatively, the blower fan 71 may include an axial fan.

According to an embodiment, through the blower device 70, a portion of the air inside the cooking chamber 21 may be sucked toward the discharge flow path 72 through a cooking chamber flow path 73 and discharged to the outside of the home appliance 1. For example, the air inside the cooking chamber 21 may be discharged to a front surface of the home appliance 1.

According to an embodiment, the discharge flow path 72 may include a bypass hole 74 for introducing part of the air flowing through the outlet 80 into the cooking chamber flow path 73. The bypass hole 74 may be opened or closed by an opening/closing device 75. As the bypass hole 74 is opened/closed by the opening/closing device 75, the amount of the part of the air flowing from the discharge flow path 72 to the outlet 80 and introduced into the cooking chamber flow path 73 may be adjusted. The amount of air exhausted from the cooking chamber 21 to the cooking chamber flow path 73 may be adjusted using the air flow adjustment.

FIG. 4 is a perspective view illustrating a main body, a door, a hinge module, and a door driving module of a home appliance according to an embodiment of the disclosure.

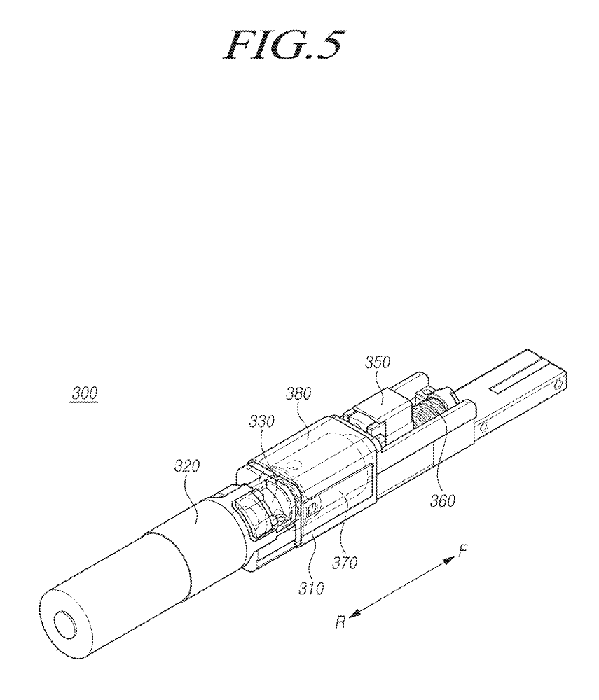

FIG. 5 is a perspective view illustrating a door driving module in a transparent manner, according to an embodiment of the disclosure.

According to an embodiment, the home appliance 1 (e.g., a cooking device) may include a main body 2, the door 50, a hinge module 200, and a door driving module 300. The main body 2 may include a housing (e.g., the housing 10 of FIGS. 1-3) and components disposed in the housing 10. The main body 2 may be configured to have a front opened by the door 50. The door 50 is rotatably connected to the main body 2 and may open or close the cooking chamber (e.g., the cooking chamber 21 of FIGS. 1-3) of the main body 2. The hinge module 200 may connect the door 50 to be rotatable about the main body 2.

According to an embodiment, the door driving module 300 is connected to the hinge module 200 and may configure the door 50 to be opened or closed in the automatic mode or the manual mode with respect to the main body 2.

The configurations of the housing 10, the door 50, and the hinge module 200 of FIGS. 4 and 5 may be identical or similar to the configurations of the housing 10, the door 50, and the hinge module 200 of FIGS. 1-3.

The embodiments of FIGS. 4 and 5 may be selectively combined with the embodiments of FIGS. 1-3 and 6-14B.

Hereinafter, an "open state" refers to a state in which the front of the main body 2 is opened so that food may be introduced into an internal chamber (e.g., the cooking chamber 21). The "open state" may refer to a state in which the door 50 rotates with respect to the main body 2 (e.g., the front panel 13 of the housing 10) to form substantially 90 degrees or more. A "closed state" refers to a state in which the front is closed so that food may not be introduced into the internal chamber (e.g., the cooking chamber 21). The "closed state" may refer to a state in which the door 50 rotates with respect to the main body 2 (e.g., the front panel 13 of the housing 10) to form substantially 0 degrees. An "intermediate state" may refer to any state between the open state and the closed state.

According to an embodiment, the open state (or opened state) of the home appliance 1 may be understood to be the same as the open state (or opened state) of the door 50. The closed state of the home appliance 1 may be understood to be the same as the closed state of the door 50.

According to an embodiment, the "automatic mode" of the door 50 may refer to a method in which the door 50 operates by itself through a motor or an electronic control device of the home appliance 1. For example, in the "automatic mode," the user may operate the motor or the electronic control device by pressing a button or through a specific action (e.g., a touch or a gesture). For example, in the "automatic mode," the user may operate the motor or the electronic control device by transmitting a voice.

According to an embodiment, the "manual mode" of the door 50 may refer to a method in which the user directly applies force to open or close the door 50. For example, in the "manual mode," the user may open or close the door by pulling or pushing the handle (e.g., the handle 52 of FIG. 1) of the door 50. For example, in the "manual mode," the home appliance 1 may move by mechanical force without motor driving.

According to an embodiment, the hinge module 200 may include a hinge body 210, a rotation lever 220, and/or an elastic lever 230. The hinge module 200 may be disposed on one side (e.g., an inner surface of the outer case 12 of the housing 10) of the main body 2. The hinge module 200 may be coupled to the main body 2 and the door 50. The hinge module 200 is connected to the door driving module 300 and may transmit a force received from the door driving module 300 to the door 50.

According to an embodiment, the hinge body 210 may support the door 50 to be rotatable about the main body 2 and transmit a force received from the door driving module 300 to the door 50. For example, the hinge body 210 may guide an open or close operation of the door 50 based on a hinge axis.

According to an embodiment, the rotation lever 220 is an arm-shaped component rotatably coupled to the hinge body 210, one side of which is connected to the hinge body 210 and the other side of which may be coupled to the door 50. For example, a portion where the rotation lever 220 is rotatably coupled to the hinge body 210 may form the hinge axis. In the automatic mode of the door 50, the rotation lever 220 may receive a driving force transmitted to the door driving module 300 and directly provide force to the door 50. In the manual mode of the door 50, the rotation lever 220 may receive a force from the user and rotate the door 50 with respect to the hinge body 210.

According to an embodiment, the elastic lever 230 is a lever structure providing tension, one side of which is connected to the hinge body 210 and the other side of which may be coupled to the door driving module 300. The elastic lever 230 may stabilize the position of the door 50 or support a return operation (e.g., a closing operation of the door 50) using energy of an elastic member (e.g., a spring). In the automatic mode or the manual mode of the door 50, the elastic lever 230 may transmit a force generated by the door driving module 300 or a force applied from the door 50 to the opposite side, and absorb an impact applied in addition to a necessary force.

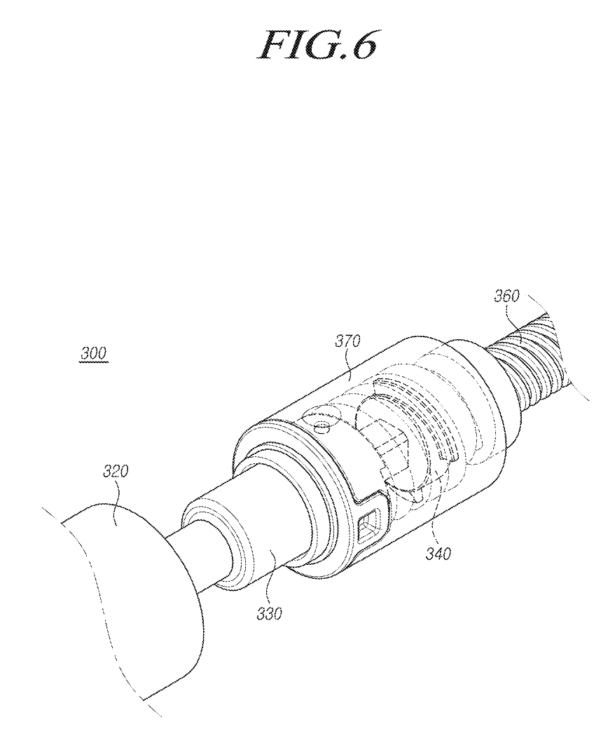

According to an embodiment, the door driving module 300 may include a case 310, a driving motor 320, a bushing 330, a transmission (e.g., the transmission 340 of FIG. 6), a transfer block 350, a first spindle 360, a second spindle 370, and/or a cover 380. The door driving module 300 may be disposed on one side (e.g., an inner surface of the outer case 12 of the housing 10) of the main body 2. The door driving module 300 is connected to the hinge module 200 and may be disposed on one side or two opposite sides of the door 50. Referring to FIG. 4, the door driving module 300 is disposed on a lower surface of the outer case 310, but this is not limited thereto, and the position of the door driving module 300 may be easily changed in various regions of the main body 2 or the door 50 for convenient driving of the door 50.

According to an embodiment, the case 310 is a structure surrounding an exterior of the door driving module 300 and may provide a space receiving internal components (e.g., the driving motor 320, the bushing 330, the transmission 340, the transfer block 350, the first spindle 360, and/or the second spindle 370). The case 310 may protect the internal components received in the space and maintain an arrangement thereof. The case 310 may protect the internal components from external impacts or foreign objects (e.g., dust, moisture). The accommodation space of the case 310 may be formed along a length direction so that the driving motor 320, the bushing 330, the transmission 340, the second spindle 370, the first spindle 360, and/or the transfer block 350 are sequentially disposed from the opposite side of the hinge module 200. The case 310 may have a half-cylindrical structure considering the shapes and arrangement of the internal components.

According to an embodiment, the driving motor 320 is positioned in the accommodation space of the case 310 and may generate a rotational force for driving the door 50. For example, the driving motor 320 may provide a driving force for the transmission 340 and/or the transfer block 350 to move in a front direction F or a rear direction R for driving the door 50. The driving motor 320 may control a rotation direction and a speed according to an electrical signal. The driving motor 320 may include a gear box. The gear box may include a reduction gear box configured to increase a torque output from the driving motor 320.

According to an embodiment, the bushing 330 (or bush) is coupled to the driving motor 320 and may transmit a driving force generated by the driving motor 320 to the transmission 340. The bushing 330 may guide movement of the transmission 340 in the front direction F or the rear direction R. The bushing 330 is a structure that reduces friction of the transmission 340 performing rotational and/or linear motion and absorbs vibration and noise, and may rotate based on a rotation axis of the driving motor 320. The bushing 330 may also be referred to by various terms such as a joint, a sleeve, an insert, or a liner capable of connecting components.

According to an embodiment, the transmission 340 is a structure that converts and transmits the rotational force of the driving motor 320 to a required form, and may include a lead screw that provides rotational and/or linear motion along a thread in the second spindle 370 for deceleration or torque increase. The transmission 340 may be applied with various lead screw specifications (e.g., lead, pitch, etc.) or gear ratios to increase driving efficiency. The transmission 340 may be designed with a structure capable of durability and low noise to stably rotate in the second spindle 370 and transmit power to other internal components.

According to an embodiment, the first spindle 360 and the second spindle 370 may rotate in conjunction with each other. In the automatic mode of the door 50, power of the driving motor 320 is transmitted from the second spindle 370 to the first spindle 360, and in the manual mode of the door 50, power transmitted by a force applied to the door 50 may be transmitted from the first spindle 360 to the second spindle 370. For example, the second spindle 370 receives the transmission 340 inside and may rotate with power received from the transmission 340. The first spindle 360 coupled to the second spindle 370 may transmit power received from the second spindle 370 to the transfer block 350. The first spindle 360 and the second spindle 370 may each include a thread.

According to an embodiment, the transfer block 350 is rotatably coupled to the first spindle 360 and may move in the front direction F or the rear direction R along an axial direction of the first spindle 360. The transfer block 350 may be connected so that power transmitted from the driving motor 320 opens or closes the door 50 through the transmission 340 and the first and second spindles 360 and 370.

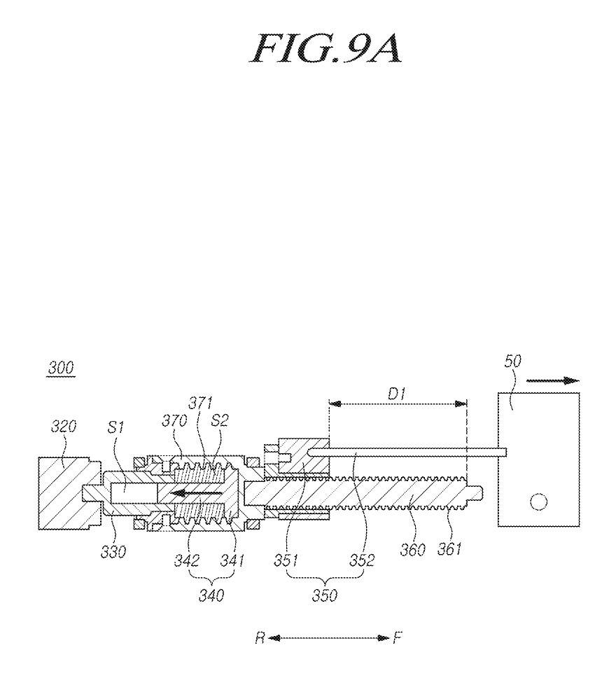

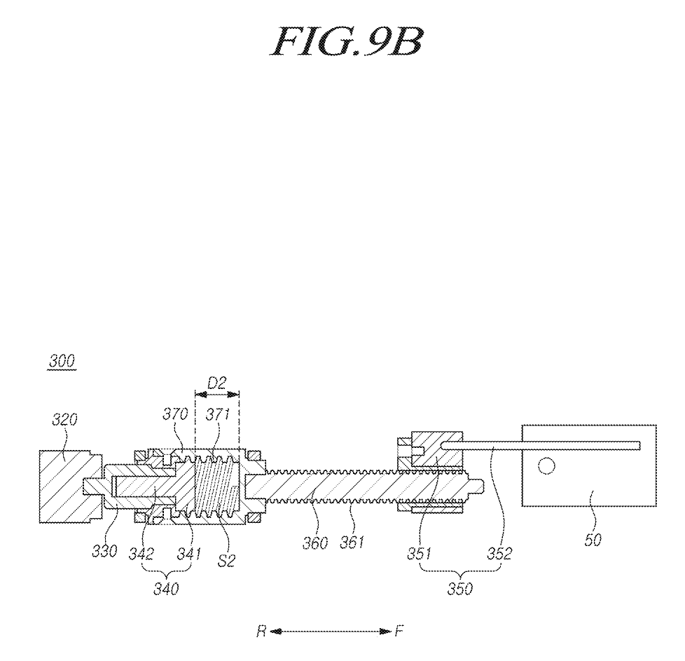

According to an embodiment, the transfer block 350 may include a nut (e.g., a nut 351 of FIGS. 9A-12C) configured to be movable along the thread of the first spindle 360, and/or a push rod (e.g., a push rod 352 of FIGS. 9A-12C) substantially connected to the door 50 or the hinge module 200 to push the door 50. For example, the transfer block 350 may be configured only with the nut 351 moving along the first spindle 360. For example, the transfer block 350 may be configured with the push rod 352 coupled to the nut 351 and coupled to the door 50.

According to an embodiment, the transfer block 350 is a member that moves to transmit a force to the door 50 or moves by receiving a force from the door 50, and may be changed to various expressions such as a moving member, a slider, a driving rod assembly, a lead driving transfer body, or a linear actuation member.

According to an embodiment, the cover 380 is a structure surrounding an exterior of the door driving module 300 and may be configured to cover an upper side of the internal components (e.g., the driving motor 320, the bushing 330, the transmission 340, the transfer block 350, the first spindle 360, and/or the second spindle 370) received in the space of the case 310. The cover 380 may block external foreign objects from entering the door driving module 300 so that rotational motion and linear motion of the internal components may be stably performed, and may be formed in a half-cylindrical structure corresponding to the shape of the case 310 considering the shapes and arrangement of the components.

Hereinafter, operations related to rotational motion and linear motion of the internal components of the door driving module 300 in the automatic mode and the manual mode of the door 50 are specifically described.

FIG. 6 is a view illustrating an associated configuration of internal components of a door driving module in a transparent manner, according to an embodiment of the disclosure.

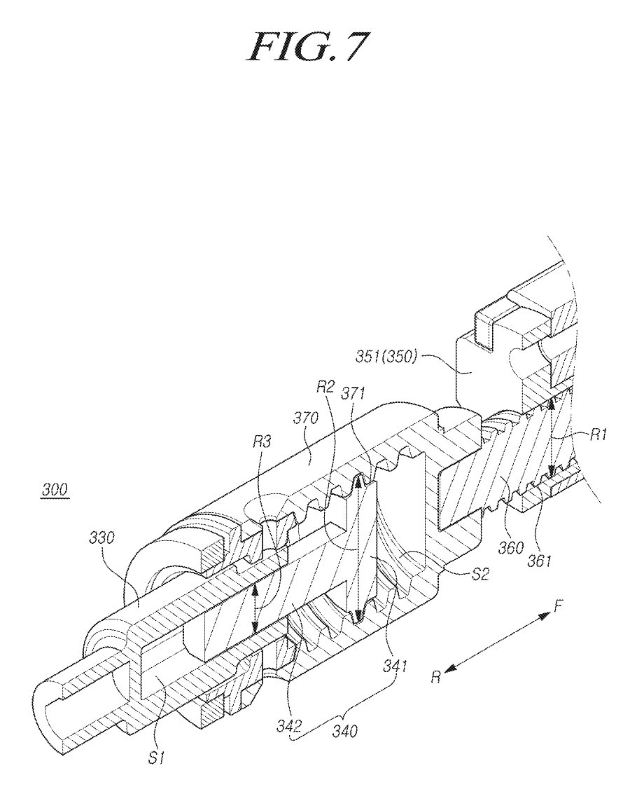

FIG. 7 is a cross-sectional view disclosing an associated configuration of internal components of a door driving module according to an embodiment of the disclosure.

According to an embodiment, the home appliance 1 may include the main body (e.g., the main body 2 of FIG. 4), the door (e.g., the door 50 of FIG. 4), the hinge module (e.g., the hinge module 200 of FIG. 4), and the door driving module 300.

According to an embodiment, the door driving module 300 is connected to the hinge module 200 and may be configured to open or close the door 50 in the automatic mode or the manual mode with respect to the main body 2.

The configurations of the housing 10, the door 50, the hinge module 200, and the door driving module 300 of FIGS. 6 and 7 may be identical or similar to the configurations of the housing 10, the door 50, the hinge module 200, and the door driving module 300 of FIGS. 1-5.

The embodiments of FIGS. 6 and 7 may be selectively combined with the embodiments of FIGS. 1 to 5 and 8-14B.

According to an embodiment, the door driving module 300 may include the case 310, the driving motor 320, the bushing 330, the transmission 340, the bushing 330, the transfer block 350, the first spindle 360, the second spindle 370, and/or the cover 380. The door driving module 300 may be movably or rotatably coupled in the order of the driving motor 320, the bushing 330, the transmission 340, the second spindle 370, the first spindle 360, and the transfer block 350 from a rear side toward a front side.

According to an embodiment, the driving motor 320 may generate a driving force (e.g., rotational force). The bushing 330 may transmit the driving force (e.g., rotational force) generated by the driving motor 320 to the transmission 340. The bushing 330 may provide a first space S1 in which the transmission 340 may move in the front direction F or the rear direction R (hereinafter, front/rear movement). The transfer block 350 may be configured to move in the front/rear direction in response to an open operation or a close operation of the door 50 in the automatic mode or the manual mode of the door 50. The first spindle 360 may be configured to guide the front/rear movement of the transfer block 350 and to rotate in response to the open or close operation of the door 50. The second spindle 370 may be configured to guide the front/rear movement of the transmission 340 and to have a front end connected to the first spindle 360 to rotate in conjunction with the rotation of the first spindle 360.

Hereinafter, the door driving module 300 is described under the assumption that a first thread 361 of the first spindle 360 and a second thread 371 of the second spindle 370 are formed in the same helical direction, such that the transmission 340 and the transfer block 350 rotate in the same direction during the open operation or the close operation of the door 50.

According to an embodiment, the door driving module 300 may be configured to include a clutch structure. The clutch structure may be understood as an associated configuration between the bushing 330, the transmission 340, the second spindle 370, and/or the first spindle 360. For example, the clutch structure may be a switchable structure between a state in which the transmission 340 is engaged with the second spindle 370 to enable power transfer to an adjacent element (e.g., the first spindle 360) (e.g., hereinafter, a clutch engagement state) and a state in which power between the transmission 340 and the second spindle 370 is interrupted (e.g., hereinafter, a clutch disengagement state). The clutch engagement state may be a state in which the manual mode of the door 50 is not possible.

According to an embodiment, the bushing 330 may transmit the power of the driving motor 320 to the transmission 340. In the clutch engagement state, the bushing 330 transmits power to the transmission 340, and the transmission 340 may perform rotational motion. In the clutch disengagement state, the bushing 330 transmits power to the transmission 340, and the transmission 340 may move in the front direction F or the rear direction R (hereinafter, front/rear movement).

According to an embodiment, the transmission 340 may include a shaft portion 342 partially received in the first space S1 of the bushing 330, and a lead screw 341 extending from the shaft portion 342 and rotatably coupled to the second thread 371 of the second spindle 370. The shaft portion 342 and the lead screw 341 have a cylindrical shape, and a first radius R1 of the shaft portion 342 may be smaller than a second radius R2 of the lead screw.

According to an embodiment, the transmission 340 may operate differently according to the automatic mode of the door 50 and the manual mode of the door 50. In the automatic mode of the door 50 (e.g., the clutch engagement state), in case that the driving motor 320 rotates, the transmission 340 may receive a rotational force from the bushing 330 and rotate the second spindle 370. In the manual mode of the door 50 (e.g., the clutch disengagement state), in case that the user opens or closes the door 50, the transmission 340 may receive a rotational force from the first spindle 360 and the second spindle 370 and perform linear motion in the front direction F or the rear direction R in the space (e.g., the first space S1 and the second space S2) formed in the second spindle 370 and the bushing 330.

According to an embodiment, the first space S1 of the bushing 330 is an open area in which the transmission 340 may move in the front/rear direction without power, and may provide a structure in which the door 50 may operate in the manual mode. For example, in the manual mode, in case that the door 50 is in the closed state, one end (e.g., the lead screw 351) of the transmission 340 may be in a state of being moved toward the door 50 side (e.g., the front direction F) in the first space S1 of the bushing 330. For example, in the manual mode, in case that the door 50 is in the open state, the other end (e.g., the shaft portion 342) of the transmission 340 may be in a state of being moved toward the driving motor 320 side (e.g., the rear direction R) in the first space S1 of the bushing 330.

According to an embodiment, the first spindle 360 is coupled to the second spindle 370 and may rotate together. The first spindle 360 has the first thread 361 formed along an outer side thereof and may guide the front/rear movement of the nut 351 of the transfer block 350 connected (e.g., engaged) to the first thread 361. The axial direction of the first spindle 360 extends from the axial direction of the driving motor 320, and the first spindle 360 and the second spindle 370 may rotate in the same rotation direction.

According to an embodiment, the first spindle 360 and the transfer block 350 guided by the first spindle 360 may operate differently according to the automatic mode of the door 50 and the manual mode of the door 50. In the automatic mode of the door 50, the transfer block 350 may rotate by a rotational force transmitted from the second spindle 370 and move the transfer block 350 screw-coupled to the first thread 361 in the front direction F or the rear direction R. In the manual mode of the door 50, in case that the user opens or closes the door 50, the transfer block 350 may move in the front direction F or the rear direction R and rotate the first spindle 360. The rotational force generated from the first spindle 360 may be transmitted to the second spindle 370 and components coupled to the second spindle 370.

According to an embodiment, the second spindle 370 is positioned between the first spindle 360 and the bushing 330, is coupled to the bushing 330 and the first spindle 360, and may rotate together. The second spindle 370 has the second thread 371 formed along an inner side thereof and may guide the rotation and/or front/rear movement of the transmission 340 (e.g., the lead screw 341) connected (e.g., engaged) to the second thread 371. The axial direction of the second spindle 370 may extend in the same direction as the axial direction of the driving motor 320 and rotate.

According to an embodiment, a portion of the second spindle 370 may be configured to cover one end of the bushing 330. The second spindle 370 forms the second space S2 in which the second thread 371 is formed, and the lead screw 341 of the transmission 340 may rotate with respect to the second spindle 370 or move in the front/rear direction together with rotation in the second space S2.

According to an embodiment, the second spindle 370 may operate differently according to the automatic mode of the door 50 and the manual mode of the door 50. In the automatic mode of the door 50, the second spindle 370 may receive power from the transmission 340 and transmit a rotational force to the first spindle 360. In the manual mode of the door 50, in case that the user opens or closes the door 50, the second spindle 370 may receive a rotational force from the first spindle 360 and move the transmission 340 in the front direction F or the rear direction R in the second space S2 formed in the second spindle 370.

According to an embodiment, a first length (e.g., a first length D1 of FIGS. 9A-12C) of the first spindle 360 may be formed to be longer than a second length (e.g., a second length D2 of FIGS. 9A-12C) of the second spindle 370. The first length D1 of the first spindle 360 is at least a portion of the length of the first thread 361 arranged along the axial direction of the first spindle 360 and may refer to a region in which the nut 351 may move in the front/rear direction. The first length D1 of the first spindle 360 may be a distance value by which the nut 351 moves from the open state of the door 50 to the closed state (or from the closed state to the open state). For example, the first length D1 may be a distance value by which a front end of the nut 351 disposed on one side of the first spindle 360 moves in the front direction F along the axial direction of the first spindle 360 to the other side of the first spindle 360. The second length D2 of the second spindle 370 is at least a portion of the length of the second thread 371 arranged along the axial direction of the second spindle 370 and may refer to a region in which the transmission 340 may move in the front/rear direction. The second length D2 of the second spindle 370 may be a distance value by which the lead screw 341 of the transmission 340 moves from the open state of the door 50 to the closed state (or from the closed state to the open state). For example, the second length D2 may be a distance value by which a front end of the lead screw 341 disposed on one side of the second spindle 370 moves in the front direction F along the axial direction of the second spindle 370 to the other side of the second spindle 370.

According to an embodiment, the door driving module 300 may provide a compact module through a structure in which a small movement distance (e.g., the second length D2) of the transmission 340 is possible compared to the movement distance (e.g., the first length D1) of the nut 351 by designing the first lead of the first spindle 360 and the second lead of the second spindle 370 differently (e.g., designing the second lead to be larger than the first lead). For example, a second diameter R2 of the second spindle 370 may be formed to be larger than a first diameter R1 of the first spindle 360. The second spindle 370 has the second diameter R2 larger than the first diameter R1 of the first spindle 360, but the second length D2 is designed to be smaller than the first length D1, so that in case that the door 50 is opened or closed, the nut 351 performs linear motion with a large movement distance (e.g., the first length D1), but the transmission 340 may implement linear motion with a relatively small movement distance (e.g., the second length D2). Accordingly, the size of the door driving module 300 may be compactly implemented by adjusting the ratio (e.g., lead) of the nut 351 and the transmission 340 guided by the first and second spindles 360 and 370.

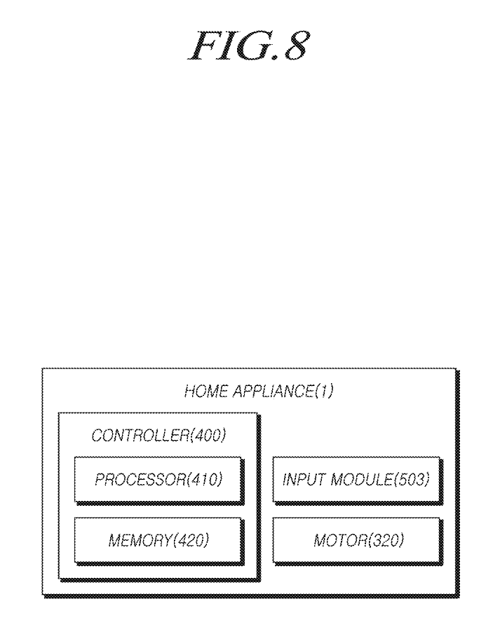

FIG. 8 is a block diagram illustrating a home appliance according to an embodiment of the disclosure.

FIGS. 9A and 9B are views illustrating an opening operation of a door in a manual mode according to an embodiment of the disclosure.

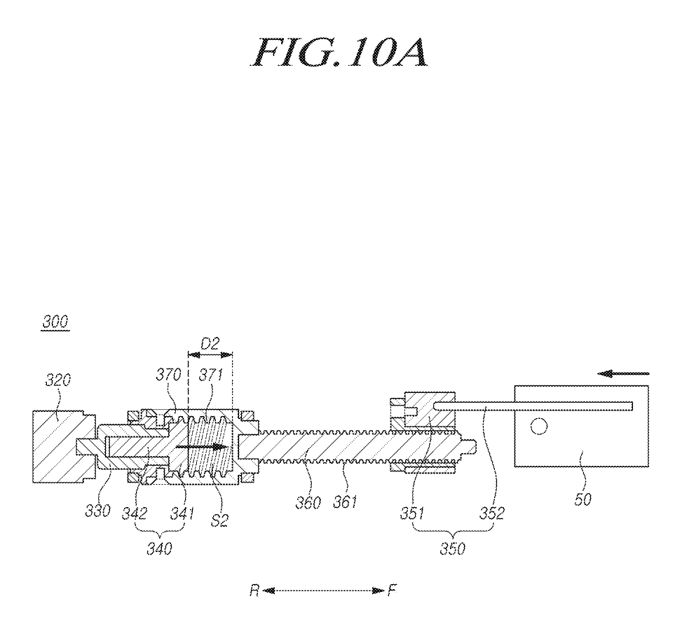

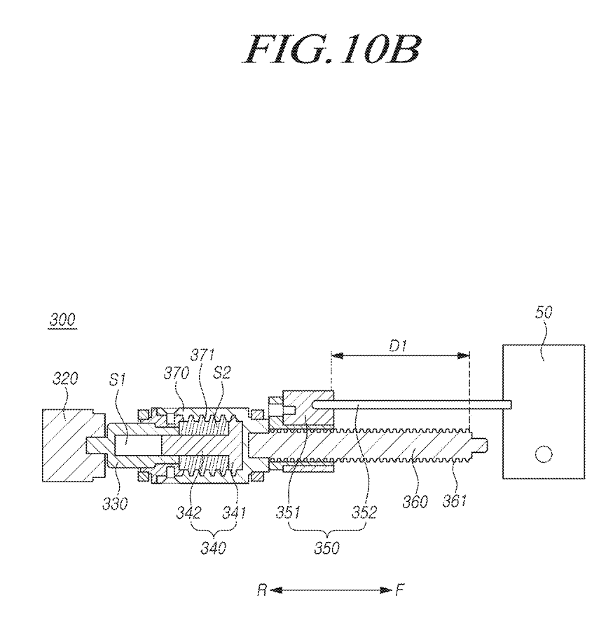

FIGS. 10A and 10B are views illustrating a closing operation of a door in a manual mode according to an embodiment of the disclosure.

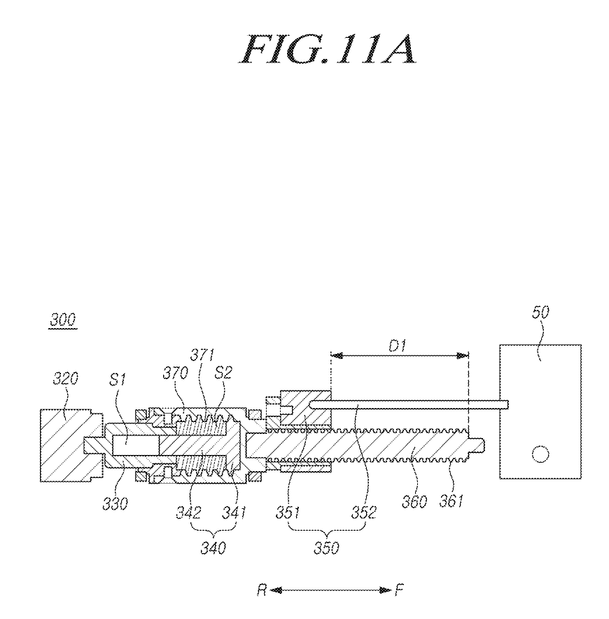

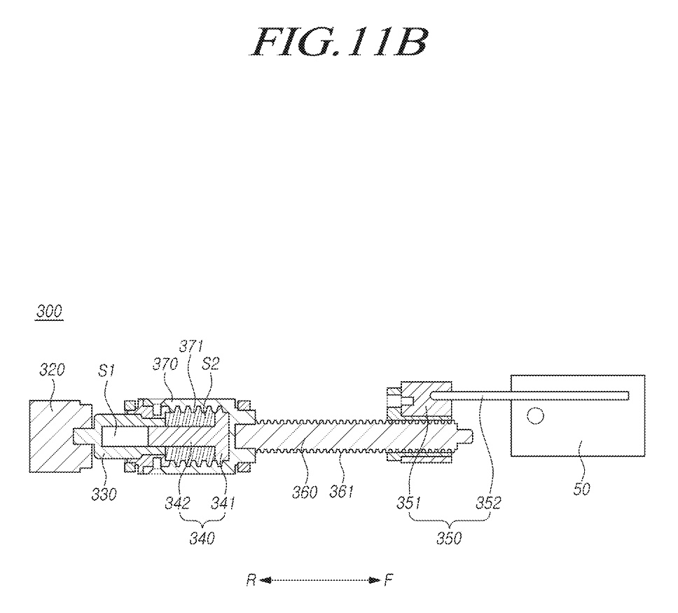

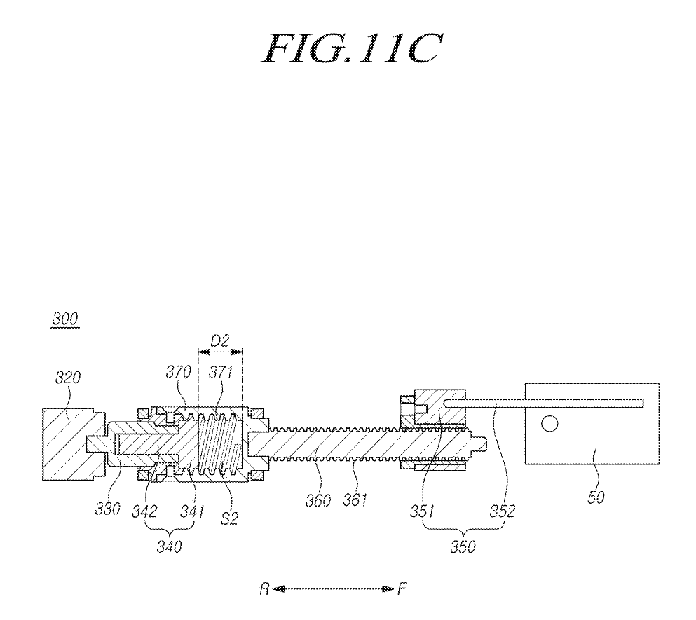

FIGS. 11A-11C are views illustrating an opening operation of a door in an automatic mode according to an embodiment of the disclosure.

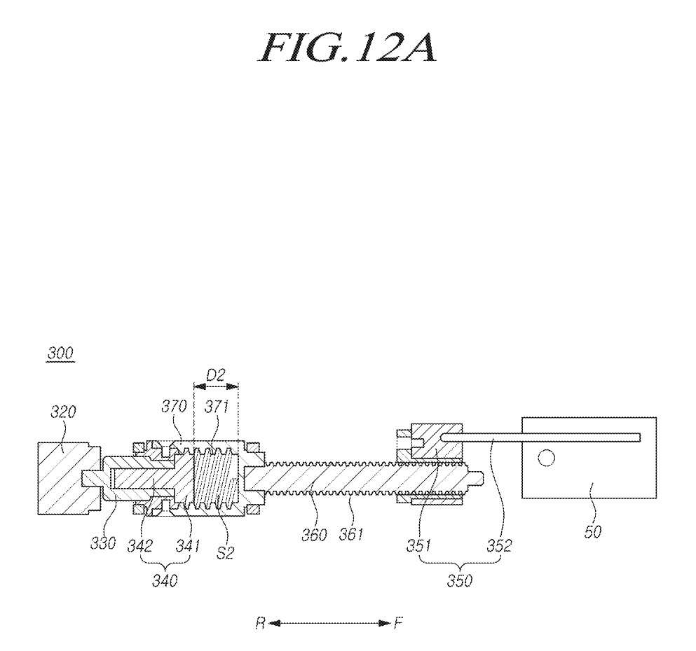

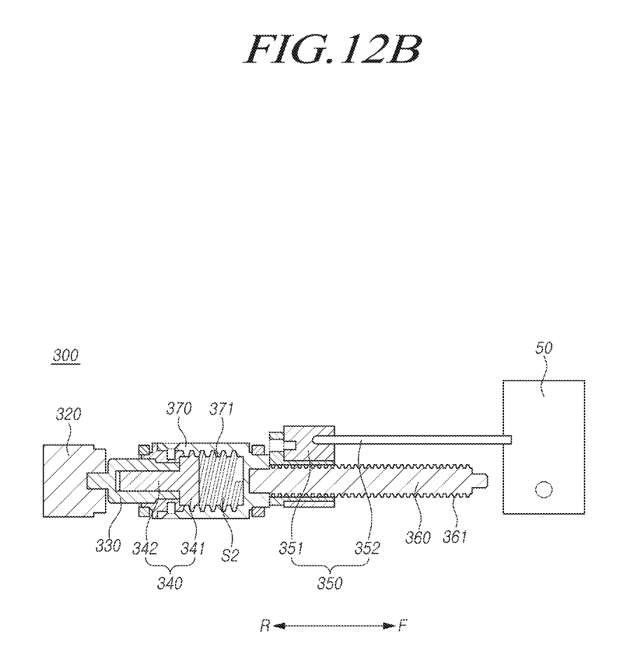

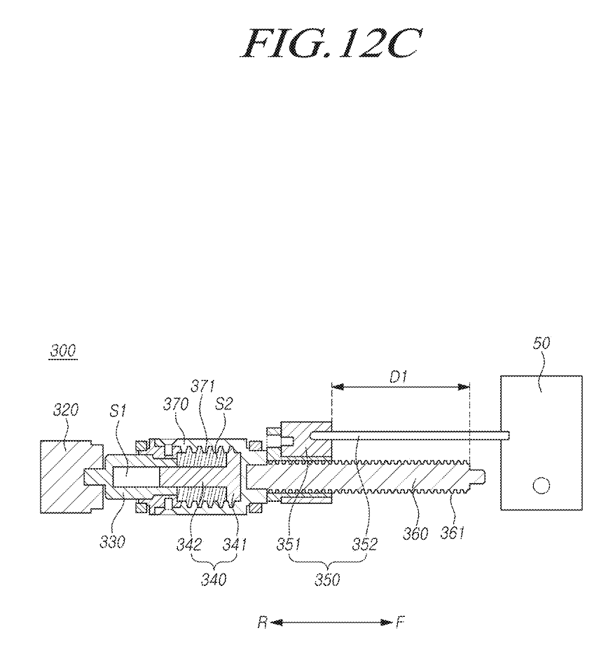

FIGS. 12A-12C are views illustrating a closing operation of a door in an automatic mode according to an embodiment of the disclosure.

According to an embodiment, the home appliance 1 may include the main body (e.g., the main body 2 of FIG. 4), the door 50, the hinge module (e.g., the hinge module 200 of FIG. 4), and the door driving module 300. The main body 2 may include a housing (e.g., the housing 10 of FIGS. 1 to 3) and components disposed in the housing 10. The main body 2 may be configured to have an open front. The door 50 is rotatably connected to the main body 2 and may open or close the cooking chamber (e.g., the cooking chamber 21 of FIGS. 1 to 3) of the main body 2. The hinge module 200 may connect the door 50 to be rotatable about the main body 2.

According to an embodiment, the door driving module 300 is connected to the hinge module 200 and may be configured to open or close the door 50 in the automatic mode or the manual mode with respect to the main body 2.

The configurations of the door 50 and the driving module 300 of FIGS. 8-12C may be identical or similar to the configurations of the door 50 and the driving module 300 of FIGS. 1-7.

The embodiments of FIGS. 8-12C may be selectively combined with the embodiments of FIGS. 1-7, 13, and 14B.

According to an embodiment, the door driving module 300 may include the driving motor 320, the bushing 330, the transmission 340, the bushing 330, the transfer block 350, the first spindle 360, and/or the second spindle 370. The door driving module 300 may be movably or rotatably disposed in the order of the driving motor 320, the bushing 330, the transmission 340, the second spindle 370, the first spindle 360, and the transfer block 350 from a rear side toward a front side. Hereinafter, description is basically made under the assumption that the first thread 361 of the first spindle 360 and the second thread 371 of the second spindle 370 are formed in the same helical direction, such that the transmission 340 and the transfer block 350 rotate in the same direction during the open operation or the close operation of the door 50.

Referring to FIG. 8, the home appliance 1 may include a controller 400 configured to control the operation of the home appliance 1 and the configurations of the home appliance 1.

According to an embodiment, the controller 400 may be implemented through a memory 420 (e.g., a non-volatile memory) configured to store data regarding an algorithm configured to control the operation of various components of the home appliance 1 or software instructions for reproducing the algorithm, and at least one processor 410 configured to perform operations described below using data stored in the memory 420. Here, the memory 420 and the processor 410 may be implemented as separate chips. Alternatively, the memory 420 and the processor 410 may be implemented as a single integrated chip.

According to an embodiment, the controller 400 may include at least one processor 410 and a memory 420.

According to an embodiment, the at least one processor 410 may include processing circuitry.

According to an embodiment, the memory 420 may store one or more instructions. The one or more instructions may cause the home appliance 1 to perform at least one operation when executed by the at least one processor 410. According to an embodiment, the operation of the home appliance 1 may be executed by the controller 400.

According to an embodiment, the home appliance 1 may include an input module 503.

According to an embodiment, the input module 503 may be configured to detect an input from a user. According to an embodiment, the input module 503 may be implemented as the control panel (e.g., the control panel 41 of FIG. 1) of the home appliance 1, but the disclosure is not limited thereto. For example, the input module 503 may include a sensor that detects a voice of the user or an action (e.g., a gesture) of the user.

According to an embodiment, in case that the user inputs a door open signal to the input module 503 (e.g., presses a door open button) to open the cooking chamber (e.g., the cooking chamber 21 of FIGS. 1-3), the controller 400 may control the operation of the driving motor 320 so that the door (e.g., the door 50 of FIGS. 1-3) performs an opening operation.

According to an embodiment, in case that the user inputs a door close signal to the input module 503 (e.g., presses a door close button) to close the cooking chamber (e.g., the cooking chamber 21 of FIGS. 1-3), the controller 400 may control the operation of the driving motor 320 so that the door (e.g., the door 50 of FIGS. 1-3) performs a closing operation.

Hereinafter, an opening operation of the door 50 or a closing operation of the door 50 of the home appliance 1 is described with reference to FIGS. 9A -12C.

According to an embodiment, in the manual mode of the door 50, the user may pull or push the door 50 to open or close the main body 2. For example, in the manual mode of the door 50, the opening operation or the closing operation of the door 50 may be performed by a force externally (e.g., by the user) applied to the door 50. In response to the opening operation or the closing operation of the door 50, the transfer block 350 may move in a front or rear direction, the movement of the transfer block 350 may rotate the first spindle 360 and the second spindle 370 interlocked with each other, and movement of the transmission 340 may be provided (caused) in the first space S1 of the bushing 330.

Referring to FIGS. 9A and 9B, in the manual mode, the door 50 may be switched from the closed state to the open state. FIG. 9A may be a state in which the door 50 is in the closed state and the user may manually open the door 50. FIG. 9B may be a state in which the door 50 is in the open state and the user may manually close the door 50.

According to an embodiment, in the closed state of the door 50 (e.g., FIG. 9A), the nut 351 of the transfer block 350 disposed on the first spindle 360 is in a state of being moved toward the driving motor side (e.g., the rear direction R), and the lead screw 341 of the transmission 340 may be in a state of being moved toward the door side (e.g., the front direction F). In the closed state of the door 50 (e.g., FIG. 9A), the nut 351 of the transfer block 350 and the lead screw 341 of the transmission 340 may be disposed adjacently. For example, the nut 351 of the transfer block 350 may be in a state of being in contact with or adjacent to (e.g., closely spaced from) a rear side end of the first spindle 360. For example, the lead screw 341 of the transmission 340 may be in a state of being in contact with or adjacent to (e.g., closely spaced from) a front side end of the second spindle 370.

According to an embodiment, in case that the door 50 performs an opening operation by a force externally (e.g., by the user) applied to the door 50, the transfer block 350 may move in the front direction F in response to the opening operation of the door 50. For example, the push rod 352 of the transfer block 350 coupled to the door 50 moves in the front direction F as the door 50 opens and may move the nut 351 coupled to the push rod 352 in the front direction F. The nut 351 of the transfer block 350 is in a state of being screw-coupled to the first thread 361 of the first spindle 360 and, in case that the nut 351 performs linear movement in the front direction F along the first thread 361, the nut 351 may rotate the first spindle 360 in the first direction (e.g., clockwise direction). The nut 351 of the transfer block 350 may move by the first length D1 of the first spindle 360.

In case that the first spindle 360 rotates in the first direction (e.g., clockwise direction), the second spindle 370 interlocked (e.g., fixedly coupled) with the first spindle 360 may rotate in the same first direction (e.g., clockwise direction) as the first spindle 360. The rotation of the second spindle 370 may move the transmission 340 screw-coupled to the second thread 371 of the second spindle 370 in the rear direction R. For example, the transmission 340 may perform linear movement in the rear direction R along the second thread 371. The lead screw 341 of the transmission 340 may move by the second length D2 of the second spindle 370. By designing the diameter of the lead screw 341 of the transmission 340 to be larger than the diameter of the first spindle 360 and designing the second length D2 to be smaller than the first length D1, the door driving module 300 may be manufactured as a compact structure in an axial direction length. The second thread 371 is disposed to protrude inward toward the second space S2 of the second spindle 370, and the lead screw 341 of the transmission 340 may move in the rear direction R in the second space S2.

The shaft portion 342 extending from a rear end of the lead screw 341 of the transmission 340 may move in the rear direction R in the first space S1 of the bushing 330. The first space S1 of the bushing 330 is a section for clutch disengagement and, in case that the shaft portion 342 of the transmission 340 moves in the first space S1, the rotational power of the transmission 340 may be interrupted without being transmitted to the bushing 330. Accordingly, the bushing 330 and the driving motor 320 coupled to the bushing 330 may maintain a current state without separate movement.

According to an embodiment, in the open state of the door 50 (e.g., FIG. 9B), the nut 351 of the transfer block 350 disposed on the first spindle 360 is in a state of being moved toward the door side (e.g., the front direction F), and the lead screw 341 of the transmission 340 may be in a state of being moved toward the driving motor side (e.g., the rear direction R). In the open state of the door 50 (e.g., FIG. 9B), the nut 351 of the transfer block 350 and the lead screw 341 of the transmission 340 may be disposed to be spaced far apart. For example, the nut 351 of the transfer block 350 may be in a state of being adjacent to a front side end of the first spindle 360. For example, the lead screw 341 of the transmission 340 may be in a state of being adjacent to a rear side end of the second spindle 370 or in a state of being in contact with or adjacent to (e.g., closely spaced from) the bushing 330. For example, a distance between the nut 351 of the transfer block 350 and the lead screw 341 of the transmission 340 may be a distance equal to or greater than a sum of the first length D1 and the second length D2.

Referring to FIGS. 10A and 10B, in the manual mode, the door 50 may be switched from the open state to the closed state. FIG. 10A may be a state in which the door 50 is in the open state and the user may manually close the door 50. FIG. 10B may be a state in which the door 50 is in the closed state and the user may manually open the door 50.

According to an embodiment, in the open state of the door 50 (e.g., FIG. 10A), the nut 351 of the transfer block 350 disposed on the first spindle 360 is in a state of being moved toward the door side (e.g., the front direction F), and the lead screw 341 of the transmission 340 may be in a state of being moved toward the driving motor side (e.g., the rear direction R). In the open state of the door 50 (e.g., FIG. 10A), the nut 351 of the transfer block 350 and the lead screw 341 of the transmission 340 may be disposed to be spaced far apart. For example, the nut 351 of the transfer block 350 may be in a state of being adjacent to a front side end of the first spindle 360. For example, the lead screw 341 of the transmission 340 may be in a state of being adjacent to a rear side end of the second spindle 370 or in a state of being in contact with or adjacent to (e.g., closely spaced from) a rear side end of the bushing 330. For example, a distance between the nut 351 of the transfer block 350 and the lead screw 341 of the transmission 340 may be a distance equal to or greater than a sum of the first length D1 and the second length D2.

According to an embodiment, in case that the door 50 performs a closing operation by a force externally (e.g., by the user) applied to the door 50, the transfer block 350 may move in the rear direction R in response to the closing operation of the door 50. For example, the push rod 352 of the transfer block 350 coupled to the door 50 moves in the rear direction R as the door 50 closes and may move the nut 351 coupled to the push rod 352 in the rear direction R. The nut 351 of the transfer block 350 is in a state of being screw-coupled to the first thread 361 of the first spindle 360 and, in case that the nut 351 performs linear movement in the rear direction R along the first thread 361, the nut 351 may rotate the first spindle 360 in a second direction (e.g., counterclockwise direction). The nut 351 of the transfer block 350 may move by the first length D1 of the first spindle 360.

In case that the first spindle 360 rotates in the second direction (e.g., counterclockwise direction), the second spindle 370 interlocked (e.g., fixedly coupled) with the first spindle 360 may rotate in the same second direction (e.g., counterclockwise direction) as the first spindle 360. The rotation of the second spindle 370 may move the transmission 340 screw-coupled to the second thread 371 of the second spindle 370 in the front direction F. For example, the transmission 340 may perform linear movement in the front direction F along the second thread 371. The lead screw 341 of the transmission 340 may move by the second length D2 of the second spindle 370. By designing the second length D2 to be smaller than the first length D1, the axial direction length of the door driving module 300 may be compactly manufactured.

The second thread 371 is disposed to protrude inward toward the second space S2 of the second spindle 370, and the lead screw 341 of the transmission 340 may move in the front direction F in the second space S2. The shaft portion 342 extending from a rear end of the lead screw 341 of the transmission 340 may move in the front direction F in the first space S1 of the bushing 330. The first space S1 of the bushing 330 is a section for clutch disengagement and, in case that the shaft portion 342 of the transmission 340 moves in the first space S1, the rotational power of the transmission 340 may be interrupted without being transmitted to the bushing 330. Accordingly, the bushing 330 and the driving motor 320 coupled to the bushing 330 may maintain a current state without separate movement.

According to an embodiment, in the closed state of the door 50 (e.g., FIG. 10B), the nut 351 of the transfer block 350 disposed on the first spindle 360 is in a state of being moved toward the driving motor side (e.g., the rear direction R), and the lead screw 341 of the transmission 340 may be in a state of being moved toward the door side (e.g., the front direction F). In the closed state of the door 50 (e.g., FIG. 10B), the nut 351 of the transfer block 350 and the lead screw 341 of the transmission 340 may be disposed adjacently. For example, the nut 351 of the transfer block 350 may be in a state of being in contact with or adjacent to (e.g., closely spaced from) a rear side end of the first spindle 360. For example, the lead screw 341 of the transmission 340 may be in a state of being in contact with or adjacent to (e.g., closely spaced from) a front side end of the second spindle 370.

According to an embodiment, in the automatic mode of the door 50, the home appliance 1 (e.g., the processor 410) may operate the driving motor 320 and transmit a driving force to the door driving module 300 to open or close the door 50. For example, in the automatic mode of the door 50, a force may be transmitted to the door 50 by the door driving module 300 and/or a hinge module connected to the door driving module 300, so that the opening operation or the closing operation of the door 50 is performed. A driving force (e.g., rotational force) transmitted from the driving motor 320 through the transmission 340 may rotate the second spindle 370 and the first spindle 360 interlocked with each other. The transfer block 350 moving in the front-rear direction along the first thread of the first spindle 360 may provide (cause) the opening operation or the closing operation of the door 50 connected to one side of the transfer block 350.

Referring to FIGS. 11A-11C, in the automatic mode, the door 50 may be switched from the closed state to the open state. FIG. 11A may be a state in which the door 50 is in the closed state and the home appliance 1 (e.g., the processor 410) may automatically open the door 50 through the door driving module 300, or the user may manually open the door 50. FIG. 11B may be a state in which the door 50 is in the open state and the user may not manually close the door 50. FIG. 11C may be a state in which the door 50 is in the open state and the home appliance 1 (e.g., the processor 410) may automatically close the door 50 through the door driving module 300, or the user may manually close the door 50.

According to an embodiment, in the closed state of the door 50 (e.g., FIG. 11A), the nut 351 of the transfer block 350 disposed on the first spindle 360 is in a state of being moved toward the driving motor side (e.g., the rear direction R), and the lead screw 341 of the transmission 340 may be in a state of being moved toward the door side (e.g., the front direction F). In the closed state of the door 50 (e.g., FIG. 9A), the nut 351 of the transfer block 350 and the lead screw 341 of the transmission 340 may be disposed adjacently. For example, the nut 351 of the transfer block 350 may be in a state of being in contact with or adjacent to (e.g., closely spaced from) a rear side end of the first spindle 360. For example, the lead screw 341 of the transmission 340 may be in a state of being in contact with or adjacent to (e.g., closely spaced from) a front side end of the second spindle 370.

According to an embodiment, in case that the driving motor 320 operates and rotates in the first direction (e.g., clockwise direction), the driving force (e.g., rotational force) of the driving motor 320 may rotate the bushing 330 coupled to a rotation axis of the driving motor 320 in the first direction (e.g., clockwise direction). The rotation of the bushing 330 may rotate the transmission 340 connected to the bushing 330 in the first direction (e.g., clockwise direction). The lead screw 341 of the transmission 340 is positioned at a front side end of the second spindle 370 (e.g., the clutch engagement state), and may transmit sufficient rotational force to the second spindle 370, and accordingly, the second spindle 370 may rotate in the first direction (e.g., clockwise direction). For example, the transmission 340 is in a state in which it may not move further in the front direction F, and is in a state in which only rotational motion is possible without linear motion (e.g., the clutch engagement state), so that the rotational force received from the bushing 330 may be completely transmitted to the second spindle 370.

In case that the second spindle 370 rotates in the first direction (e.g., clockwise direction), the first spindle 360 interlocked (e.g., fixedly coupled) with the second spindle 370 may rotate in the same first direction (e.g., clockwise direction) as the second spindle 370. The rotation of the first spindle 360 may move the nut 351 of the transfer block 350 screw-coupled to the first thread 361 of the first spindle 360 in the front direction F. The nut 351 of the transfer block 350 may move by the first length D1 of the first spindle 360.

The movement of the transfer block 350 in the front direction F may press the door 50 to proceed with the opening operation of the door 50. For example, the front side movement of the nut 351 of the transfer block 350 may move the push rod 352 coupled to the nut 351 in the front direction F and open the door 50 coupled to the push rod 352.

According to an embodiment, in one state (e.g., FIG. 11B) of the open state of the door 50, the nut 351 of the transfer block 350 disposed on the first spindle 360 is in a state of being moved toward the door side (e.g., the front direction F), and the lead screw 341 of the transmission 340 may also be in a state of being moved toward the door side (e.g., the front direction F). In one state (e.g., FIG. 11B) of the open state of the door 50, since the transmission 340 is in a state in which it is engaged with the second spindle 370 to enable power transfer (e.g., the clutch engagement state), the door 50 may be in a state in which the manual mode is not possible. Therefore, in order for the user to easily manually open or close the door, it is necessary to convert to a state in which power between the transmission 340 and the second spindle 370 is interrupted (e.g., the clutch disengagement state).

In order to switch to a state in which the manual mode (and automatic mode) of the door 50 is possible (e.g., operation from FIGS. 11B-11C), the home appliance 1 may perform the following additional operation.

According to an embodiment, in case that the driving motor 320 operates and rotates in the second direction (e.g., counterclockwise direction), the driving force (e.g., rotational force) of the driving motor 320 may rotate the bushing 330 coupled to a rotation axis of the driving motor 320 in the second direction (e.g., counterclockwise direction). The rotation of the bushing 330 may move the transmission 340 connected to the bushing 330 in the rear direction R. The transmission 340 may receive rotational force from the bushing 330 and move toward the inside (e.g., the rear direction R) of the first space S1 of the bushing 330 while rotating along the second thread 371 of the second spindle 370. In case that the transmission 340 rotates in the second direction (e.g., counterclockwise direction), the second spindle 370 is in a fixed state, and the lead screw 341 of the transmission 340 may move by the second length D2 of the second spindle 370. Since the second spindle 370 is in a fixed state, the first spindle 360 and the transfer block 350 interlocked therewith may be in a fixed state without moving or rotating.

As the shaft portion 342 extending from a rear end of the lead screw 341 of the transmission 340 moves in the rear direction R in the first space S1 of the bushing 330, the state may be converted to a state in which power between the transmission 340 and the second spindle 370 is interrupted (e.g., the clutch disengagement state). Accordingly, the door 50 is in a state in which the manual mode (and automatic mode) is possible, so that the user may manually close the door 50.

According to an embodiment, in the open state of the door 50 (e.g., FIG. 11C), the nut 351 of the transfer block 350 disposed on the first spindle 360 is in a state of being moved toward the door side (e.g., the front direction F), and the lead screw 341 of the transmission 340 may be in a state of being moved toward the driving motor side (e.g., the rear direction R). In the open state of the door 50 (e.g., FIG. 11C), the nut 351 of the transfer block 350 and the lead screw 341 of the transmission 340 may be disposed to be spaced far apart. For example, the nut 351 of the transfer block 350 may be in a state of being adjacent to a front side end of the first spindle 360. For example, the lead screw 341 of the transmission 340 may be in a state of being adjacent to a rear side end of the second spindle 370 or in a state of being in contact with or adjacent to (e.g., closely spaced from) the bushing 330. For example, a distance between the nut 351 of the transfer block 350 and the lead screw 341 of the transmission 340 may be a distance equal to or greater than a sum of the first length D1 and the second length D2.

Referring to FIGS. 12A-12C, in the automatic mode, the door 50 may be switched from the open state to the closed state. FIG. 12A may be a state in which the door 50 is in the open state and the home appliance 1 (e.g., the processor 410) may automatically close the door 50 through the door driving module 300, or the user may manually close the door 50. FIG. 12B may be a state in which the door 50 is in the closed state and the user may not manually open the door 50. FIG. 12C may be a state in which the door 50 is in the closed state and the home appliance 1 (e.g., the processor 410) may automatically open the door 50 through the door driving module 300, or the user may manually open the door 50.

According to an embodiment, in the open state of the door 50 (e.g., FIG. 12A), the nut 351 of the transfer block 350 disposed on the first spindle 360 is in a state of being moved toward the door side (e.g., the front direction F), and the lead screw 341 of the transmission 340 may be in a state of being moved toward the driving motor side (e.g., the rear direction R). In the open state of the door 50 (e.g., FIG. 12A), the nut 351 of the transfer block 350 and the lead screw 341 of the transmission 340 may be disposed to be spaced far apart. For example, the nut 351 of the transfer block 350 may be in a state of being adjacent to a front side end of the first spindle 360. For example, the lead screw 341 of the transmission 340 may be in a state of being adjacent to a rear side end of the second spindle 370 or in a state of being in contact with or adjacent to (e.g., closely spaced from) a rear side end of the bushing 330. For example, a distance between the nut 351 of the transfer block 350 and the lead screw 341 of the transmission 340 may be a distance equal to or greater than a sum of the first length D1 and the second length D2.

According to an embodiment, in case that the driving motor 320 operates and rotates in the second direction (e.g., counterclockwise direction), the driving force (e.g., rotational force) of the driving motor 320 may rotate the bushing 330 coupled to a rotation axis of the driving motor 320 in the second direction (e.g., counterclockwise direction). The rotation of the bushing 330 may rotate the transmission 340 connected to the bushing 330 in the second direction (e.g., counterclockwise direction). The lead screw 341 of the transmission 340 is positioned at a rear side end of the second spindle 370 (e.g., the clutch engagement state), and may transmit sufficient rotational force to the second spindle 370, and accordingly, the second spindle 370 may rotate in the second direction (e.g., counterclockwise direction). For example, the transmission 340 is in a state in which it may not move further in the rear direction R, and is in a state in which only rotational motion is possible without linear motion (e.g., the clutch engagement state), so that the rotational force received from the bushing 330 may be completely transmitted to the second spindle 370.

In case that the second spindle 370 rotates in the second direction (e.g., counterclockwise direction), the first spindle 360 interlocked (e.g., fixedly coupled) with the second spindle 370 may rotate in the same second direction (e.g., counterclockwise direction) as the second spindle 370. The rotation of the first spindle 360 may move the nut 351 of the transfer block 350 screw-coupled to the first thread 361 of the first spindle 360 in the rear direction R. The nut 351 of the transfer block 350 may move by the first length D1 of the first spindle 360.

The movement of the transfer block 350 in the rear direction R may pull the door 50 to proceed with the closing operation of the door 50. For example, the rear side movement of the nut 351 of the transfer block 350 may move the push rod 352 coupled to the nut 351 in the rear direction R and close the door 50 coupled to the push rod 352.

According to an embodiment, in one state (e.g., FIG. 12B) of the closed state of the door 50, the nut 351 of the transfer block 350 disposed on the first spindle 360 is in a state of being moved toward the driving motor side (e.g., the rear direction R), and the lead screw 341 of the transmission 340 may also be in a state of being moved toward the driving motor side (e.g., the rear direction R). In one state (e.g., FIG. 12B) of the closed state of the door 50, since the transmission 340 is in a state in which it is engaged with the second spindle 370 to enable power transfer (e.g., the clutch engagement state), the door 50 may be in a state in which the manual mode is not possible. Therefore, in order for the user to easily manually open or close the door, it is necessary to convert to a state in which power between the transmission 340 and the second spindle 370 is interrupted (e.g., the clutch disengagement state).

In order to switch to a state in which the manual mode (and automatic mode) of the door 50 is possible (e.g., operation from FIGS. 12B-12C), the home appliance 1 may perform the following additional operation.

According to an embodiment, in case that the driving motor 320 operates and rotates in the first direction (e.g., clockwise direction), the driving force (e.g., rotational force) of the driving motor 320 may rotate the bushing 330 coupled to a rotation axis of the driving motor 320 in the first direction (e.g., clockwise direction). The rotation of the bushing 330 may move the transmission 340 connected to the bushing 330 in the front direction F. The transmission 340 may receive rotational force from the bushing 330 and move toward the outside (e.g., the front direction F) of the first space S1 of the bushing 330 while rotating along the second thread 371 of the second spindle 370. In case that the transmission 340 rotates in the first direction (e.g., clockwise direction), the second spindle 370 is in a fixed state, and the lead screw 341 of the transmission 340 may move by the second length D2 of the second spindle 370. Since the second spindle 370 is in a fixed state, the first spindle 360 and the transfer block 350 interlocked therewith may be in a fixed state without moving or rotating.

As the shaft portion 342 extending from a rear end of the lead screw 341 of the transmission 340 moves in the front direction F in the first space S1 of the bushing 330, the state may be converted to a state in which power between the transmission 340 and the second spindle 370 is interrupted (e.g., the clutch disengagement state). Accordingly, the door 50 is in a state in which the manual mode (and automatic mode) is possible, so that the user may manually open the door 50.

According to an embodiment, in the closed state of the door 50 (e.g., FIG. 12C), the nut 351 of the transfer block 350 disposed on the first spindle 360 is in a state of being moved toward the driving motor side (e.g., the rear direction R), and the lead screw 341 of the transmission 340 may be in a state of being moved toward the door side (e.g., the front direction F). In the closed state of the door 50 (e.g., FIG. 12C), the nut 351 of the transfer block 350 and the lead screw 341 of the transmission 340 may be disposed adjacently. For example, the nut 351 of the transfer block 350 may be in a state of being in contact with or adjacent to (e.g., closely spaced from) a rear side end of the first spindle 360. For example, the lead screw 341 of the transmission 340 may be in a state of being in contact with or adjacent to (e.g., closely spaced from) a front side end of the second spindle 370.

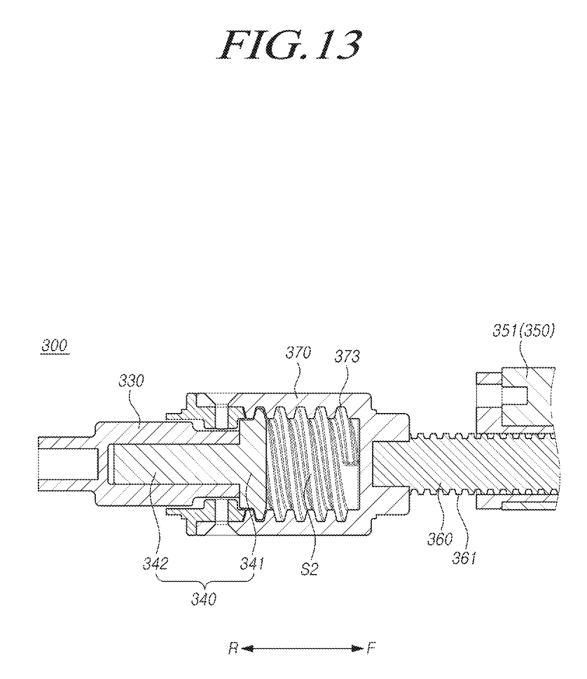

FIG. 13 is a cross-sectional view disclosing an associated configuration of internal components of a door driving module according to an embodiment of the disclosure.

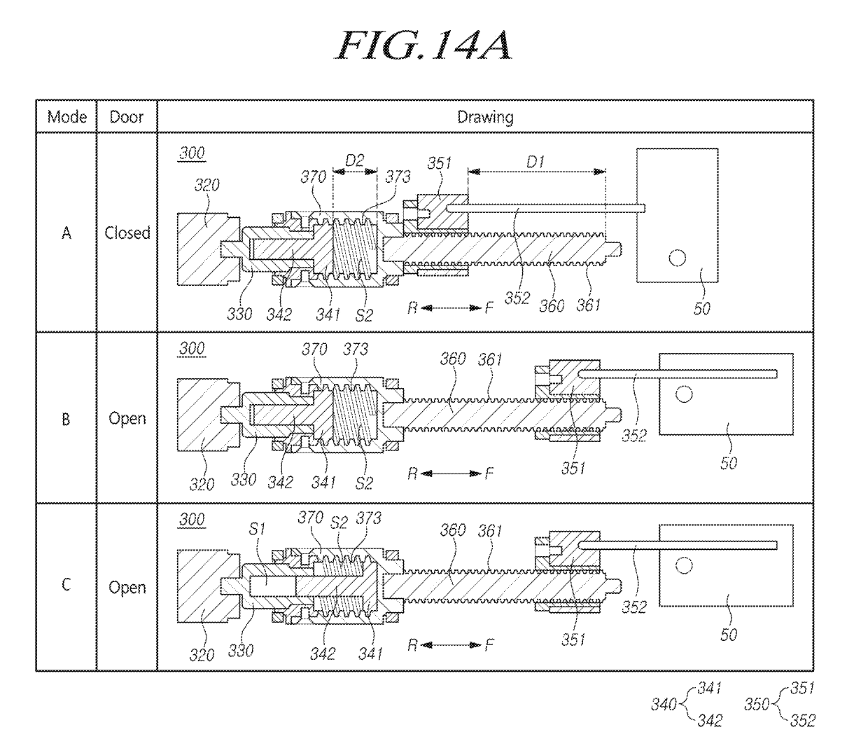

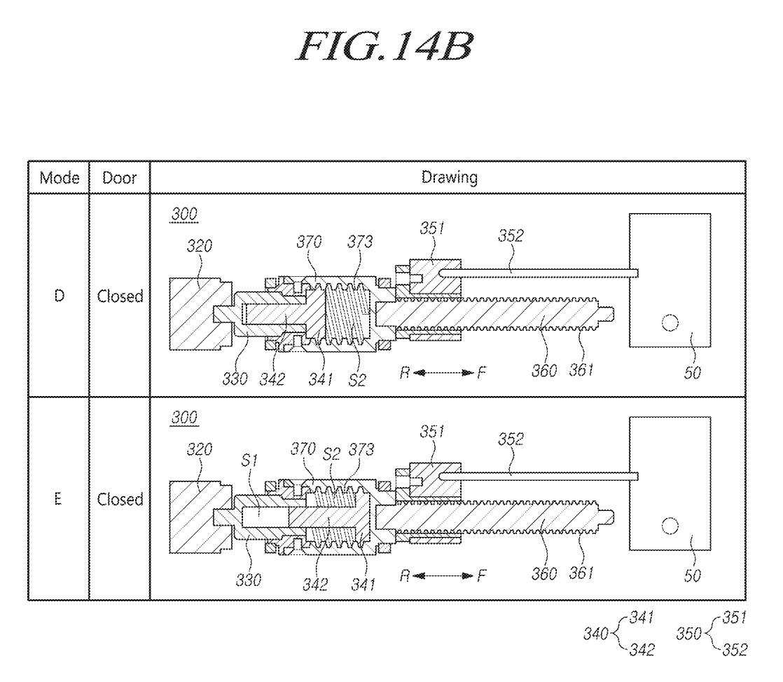

FIGS. 14A and 14B are views illustrating states of a door driving module related to the manual and automatic modes of a door and the open and closed states of the door according to an embodiment of the disclosure.

According to an embodiment, the home appliance 1 may include the main body (e.g., the main body 2 of FIG. 4), the door 50, the hinge module (e.g., the hinge module 200 of FIG. 4), and the door driving module 300.

According to an embodiment, the door driving module 300 is connected to the hinge module 200 and may be configured to open or close the door 50 in the automatic mode or the manual mode with respect to the main body 2.

The configurations of the door 50 and the door driving module 300 of FIGS. 13-14B may be identical or similar to the configurations of the door 50 and the door driving module 300 of FIGS. 1-12C.

The embodiments of FIGS. 13-14B may be selectively combined with the embodiments of FIGS. 1-12C.

Some components of the door driving module 300 of FIGS. 13-14B may operate differently from the door driving module 300 of FIGS. 6-12C. The second spindle 370 of the door driving module 300 of FIGS. 13, 14A, and 14B includes a third thread 373 disposed inside, and the third thread 373 may be formed in a helical direction opposite to the second thread 371 of the second spindle 370 of the door driving module 300 of FIGS. 6-12C. Accordingly, the movement of the transmission 340 of FIGS. 13-14B may operate in the opposite direction to the movement of the transmission 340 of FIGS. 6-12C. A configuration related thereto is specifically described.

According to an embodiment, the door driving module 300 may include the driving motor 320, the bushing 330, the transmission 340, the transfer block 350, the first spindle 360, and/or the second spindle 370. The door driving module 300 may be movably or rotatably disposed in the order of the driving motor 320, the bushing 330, the transmission 340, the second spindle 370, the first spindle 360, and the transfer block 350 from a rear side toward a front side.

According to an embodiment, the driving motor 320 may generate a driving force (e.g., rotational force). The bushing 330 may transmit the driving force (e.g., rotational force) generated by the driving motor 320 to the transmission 340 and provide the first space S1 in which the transmission 340 may move in the front direction F or the rear direction R. The transfer block 350 may be configured to move in the front direction F or the rear direction R (hereinafter, front/rear movement) in response to an open operation or a close operation of the door 50 in the automatic mode or the manual mode of the door 50. The first spindle 360 may be configured to guide the front/rear movement of the transfer block 350 and to rotate in response to the open or close operation of the door 50. The second spindle 370 may be configured to guide the front/rear movement of the transmission 340 and to have a front end connected to the first spindle 360 to rotate in conjunction with the rotation of the first spindle 360.

Hereinafter, the door driving module 300 is described under the assumption that the first thread 361 of the first spindle 360 and the third thread 373 of the second spindle 370 are formed in opposite helical directions, such that the transmission 340 and the transfer block 350 rotate in opposite directions during the open operation or the close operation of the door 50.

According to an embodiment, the door driving module 300 may be configured to include a clutch structure. The clutch structure may be understood as an associated configuration between the bushing 330, the transmission 340, the second spindle 370, and/or the first spindle 360. For example, the clutch structure may be a switchable structure between a state in which the transmission 340 is engaged with the second spindle 370 to enable power transfer to an adjacent element (e.g., the first spindle 360) (e.g., hereinafter, a clutch engagement state) and a state in which power between the transmission 340 and the second spindle 370 is interrupted (e.g., hereinafter, a clutch disengagement state). The clutch engagement state may be a state in which the manual mode of the door 50 is not possible.

According to an embodiment, the bushing 330 may transmit the power of the driving motor 320 to the transmission 340. In the clutch engagement state, the bushing 330 transmits power to the transmission 340, and the transmission 340 may perform rotational motion. In the clutch disengagement state, the bushing 330 transmits power to the transmission 340, and the transmission 340 may move in the front direction F or the rear direction R (hereinafter, front/rear movement).

According to an embodiment, the bushing 330 may provide the first space S1 in which the transmission 340 may move in the front/rear direction in a state in which a portion (e.g., the shaft portion 342) of the transmission 340 is inserted. The first space S1 of the bushing 330 is a section for clutch disengagement and, in case that the shaft portion 342 of the transmission 340 moves in the first space S1, the rotational power of the transmission 340 may be interrupted without being transmitted to the bushing 330.

According to an embodiment, the transmission 340 may include the shaft portion 342 partially received in the first space S1 of the bushing 330, and the lead screw 341 extending from the shaft portion 342 and rotatably coupled to the third thread 373 of the second spindle 370. The shaft portion 342 and the lead screw 341 have a cylindrical shape, and a radius of the shaft portion 342 may be smaller than a radius of the lead screw.

According to an embodiment, the transmission 340 may operate differently according to the automatic mode of the door 50 and the manual mode of the door 50. In the automatic mode of the door 50 (e.g., the clutch engagement state), in case that the driving motor 320 rotates, the transmission 340 may receive a rotational force from the bushing 330 and rotate the second spindle 370. In the manual mode of the door 50 (e.g., the clutch disengagement state), in case that the user opens or closes the door 50, the transmission 340 may receive a rotational force from the first spindle 360 and the second spindle 370 and perform linear motion in the front direction F or the rear direction R in the space (e.g., the first space S1 and the second space S2) formed in the second spindle 370 and the bushing 330.

According to an embodiment, the first spindle 360 is coupled to the second spindle 370 and may rotate together. The first spindle 360 has the first thread 361 formed along an outer side thereof and may guide the front/rear movement of the nut 351 of the transfer block 350 connected (e.g., engaged) to the first thread 361.

According to an embodiment, the second spindle 370 is positioned between the first spindle 360 and the bushing 330, is coupled to the bushing 330 and the first spindle 360, and may rotate together. The second spindle 370 has the third thread 373 formed along an inner side thereof and may guide the rotation and/or front/rear movement of the transmission 340 (e.g., the lead screw 341) connected (e.g., engaged) to the third thread 373.

According to an embodiment, the door driving module 300 may provide a compact module through a structure in which a small movement distance (e.g., the second length D2) of the transmission 340 is possible compared to the movement distance (e.g., the first length D1) of the nut 351 by designing the first lead of the first spindle 360 and the second lead of the second spindle 370 differently (e.g., designing the second lead to be larger than the first lead).

Referring to FIGS. 14A and 14B, the states of the door driving module 300 and the door 50 coupled thereto are separately disclosed. A state A may be defined as a basic state in which the door 50 is closed and the automatic mode and the manual mode of the door 50 are possible. A state B may be defined as a state in which the door is open and a closing operation of the door 50 is not possible in the manual mode. A state C may be defined as a state in which the door is open and a closing operation of the door 50 is possible in the manual mode. A state D may be defined as a state in which the door 50 is closed and an opening operation of the door 50 is not possible in the manual mode. A state E may be defined as a state in which the door 50 is closed and an opening operation of the door 50 is possible in the manual mode.

According to an embodiment, the opening operation of the door 50 in the manual mode of the door 50 may be performed by switching from the state A to the state C.

According to an embodiment, the closing operation of the door 50 in the manual mode of the door 50 may be performed by switching from the state C to the state A.

According to an embodiment, the opening operation of the door 50 in the automatic mode of the door 50 may be performed by switching from the state A to the state B and switching from the state B to the state C. The switching from the state B to the state C may be performed through an operation of changing a position of the transmission 340 for the manual mode of the door 50. The position change of the transmission 340 may be performed by movement of the transmission 340 toward the door lateral direction (e.g., the front direction F) in the space of the second spindle 370 and/or the bushing 330.

According to an embodiment, the closing operation of the door 50 in the automatic mode of the door 50 may be performed by switching from the state C to the state D and switching from the state D to the state A. The switching from the state D to the state A may be performed through an operation of changing a position of the transmission 340 for the manual mode of the door 50. The position change of the transmission 340 may be performed by movement of the transmission 340 toward the driving motor lateral direction (e.g., the rear direction R) in the space of the second spindle 370 and/or the bushing 330.

According to an embodiment, the opening operation of the door 50 in the manual mode of the door 50 (e.g., switching from the state A to the state C) is described.

According to an embodiment, in the closed state of the door 50 (e.g., the state A), the nut 351 of the transfer block 350 disposed on the first spindle 360 is in a state of being moved toward the driving motor side (e.g., the rear direction R), and the lead screw 341 of the transmission 340 may also be in a state of being moved toward the driving motor side (e.g., the rear direction R). In the closed state of the door 50 (e.g., the state A), the nut 351 of the transfer block 350 and the lead screw 341 of the transmission 340 may be disposed to be spaced apart. For example, the nut 351 of the transfer block 350 may be in a state of being adjacent to (e.g., closely spaced from) a rear side end of the first spindle 360. For example, the lead screw 341 of the transmission 340 may be in a state of being adjacent to a rear side end of the second spindle 370 or in a state of being in contact with or adjacent to (e.g., closely spaced from) the bushing 330. For example, a distance between the nut 351 of the transfer block 350 and the lead screw 341 of the transmission 340 may be a distance equal to or greater than the second length D2.

According to an embodiment, in case that the door 50 performs an opening operation by a force externally (e.g., by the user) applied to the door 50, the transfer block 350 may move in the front direction F in response to the opening operation of the door 50. For example, the push rod 352 of the transfer block 350 coupled to the door 50 moves in the front direction F as the door 50 opens and may move the nut 351 coupled to the push rod 352 in the front direction F. The nut 351 of the transfer block 350 is in a state of being screw-coupled to the first thread 361 of the first spindle 360 and, in case that the nut 351 performs linear movement in the front direction F along the first thread 361, the nut 351 may rotate the first spindle 360 in the first direction (e.g., clockwise direction). The nut 351 of the transfer block 350 may move by the first length D1 of the first spindle 360.

In case that the first spindle 360 rotates in the first direction (e.g., clockwise direction), the second spindle 370 interlocked (e.g., fixedly coupled) with the first spindle 360 may rotate in a second direction (e.g., counterclockwise direction) opposite to the first spindle 360. The rotation of the second spindle 370 may move the transmission 340 screw-coupled to the third thread 373 of the second spindle 370 in the front direction F. For example, the transmission 340 may perform linear movement in the front direction F along the third thread 373. The lead screw 341 of the transmission 340 may move by the second length D2 of the second spindle 370. By designing the diameter of the lead screw 341 of the transmission 340 to be larger than the diameter of the first spindle 360 and designing the second length D2 to be smaller than the first length D1, the door driving module 300 may be manufactured as a compact structure in an axial direction length. The second thread 371 is disposed to protrude inward toward the second space S2 of the second spindle 370, and the lead screw 341 of the transmission 340 may move in the rear direction R in the second space S2.

The shaft portion 342 extending from a rear end of the lead screw 341 of the transmission 340 may move in the front direction F in the first space S1 of the bushing 330. The first space S1 of the bushing 330 is a section for clutch disengagement and, in case that the shaft portion 342 of the transmission 340 moves in the first space S1, the rotational power of the transmission 340 may be interrupted without being transmitted to the bushing 330. Accordingly, the bushing 330 and the driving motor 320 coupled to the bushing 330 may maintain a current state without separate movement.

According to an embodiment, in the open state of the door 50 (e.g., the state C), the nut 351 of the transfer block 350 disposed on the first spindle 360 is in a state of being moved toward the door side (e.g., the front direction F), and the lead screw 341 of the transmission 340 may also be in a state of being moved toward the door side (e.g., the front direction F). In the open state of the door 50 (e.g., the state C), the nut 351 of the transfer block 350 and the lead screw 341 of the transmission 340 may be disposed to be more spaced apart than in the closed state of the door 50 (e.g., the state A). For example, the nut 351 of the transfer block 350 may be in a state of being adjacent to a front side end of the first spindle 360. For example, the lead screw 341 of the transmission 340 may be in a state of being in contact with or adjacent to (e.g., closely spaced from) a front side end of the second spindle 370. For example, a distance between the nut 351 of the transfer block 350 and the lead screw 341 of the transmission 340 may be a distance equal to or greater than the first length D1.

According to an embodiment, the closing operation of the door 50 in the manual mode of the door 50 (e.g., switching from the state C to the state A) may be described in the reverse order of the opening operation of the door 50.

According to an embodiment, the opening operation of the door 50 in the automatic mode of the door 50 (e.g., proceeding in the order of the state A, the state B, and the state C) is described.

According to an embodiment, in the closed state of the door 50 (e.g., the state A), the nut 351 of the transfer block 350 disposed on the first spindle 360 is in a state of being moved toward the driving motor side (e.g., the rear direction R), and the lead screw 341 of the transmission 340 may also be in a state of being moved toward the driving motor side (e.g., the rear direction R). In the closed state of the door 50 (e.g., the state A), the nut 351 of the transfer block 350 and the lead screw 341 of the transmission 340 may be disposed to be spaced apart. For example, the nut 351 of the transfer block 350 may be in a state of being adjacent to (e.g., closely spaced from) a rear side end of the first spindle 360. For example, the lead screw 341 of the transmission 340 may be in a state of being adjacent to a rear side end of the second spindle 370 or in a state of being in contact with or adjacent to (e.g., closely spaced from) the bushing 330. For example, a distance between the nut 351 of the transfer block 350 and the lead screw 341 of the transmission 340 may be a distance equal to or greater than the second length D2.

According to an embodiment, in case that the driving motor 320 operates and rotates in the first direction (e.g., clockwise direction), the driving force (e.g., rotational force) of the driving motor 320 may rotate the bushing 330 coupled to a rotation axis of the driving motor 320 in the first direction (e.g., clockwise direction). The rotation of the bushing 330 may rotate the transmission 340 connected to the bushing 330 in the second direction (e.g., counterclockwise direction). The lead screw 341 of the transmission 340 is positioned at a rear side end of the second spindle 370 (e.g., the clutch engagement state), and may transmit sufficient rotational force to the second spindle 370, and accordingly, the second spindle 370 may rotate in the first direction (e.g., clockwise direction). For example, the transmission 340 is in a state in which it may not move further in the rear direction R, and is in a state in which only rotational motion is possible without linear motion (e.g., the clutch engagement state), so that the rotational force received from the bushing 330 may be completely transmitted to the second spindle 370.

In case that the second spindle 370 rotates in the first direction (e.g., clockwise direction), the first spindle 360 interlocked (e.g., fixedly coupled) with the second spindle 370 may rotate in the same first direction (e.g., clockwise direction) as the second spindle 370. The rotation of the first spindle 360 may move the nut 351 of the transfer block 350 screw-coupled to the first thread 361 of the first spindle 360 in the front direction F. The nut 351 of the transfer block 350 may move by the first length D1 of the first spindle 360.

The movement of the transfer block 350 in the front direction F may press the door 50 to proceed with the opening operation of the door 50. For example, the front side movement of the nut 351 of the transfer block 350 may move the push rod 352 coupled to the nut 351 in the front direction F and open the door 50 coupled to the push rod 352.

According to an embodiment, in one state (e.g., the state B) of the open state of the door 50, the nut 351 of the transfer block 350 disposed on the first spindle 360 is in a state of being moved toward the door side (e.g., the front direction F), and the lead screw 341 of the transmission 340 may be in a state of being moved toward the driving motor side (e.g., the rear direction R). In one state (e.g., the state B) of the open state of the door 50, since the transmission 340 is in a state in which it is engaged with the second spindle 370 to enable power transfer (e.g., the clutch engagement state), the door 50 may be in a state in which the manual mode is not possible. Therefore, in order for the user to easily manually open or close the door, it is necessary to convert to a state in which power between the transmission 340 and the second spindle 370 is interrupted (e.g., the clutch disengagement state).

In order to switch to a state in which the manual mode (and automatic mode) of the door 50 is possible (e.g., operation from the state B to the state C), the home appliance 1 may perform the following additional operation.

According to an embodiment, in case that the driving motor 320 operates and rotates in the second direction (e.g., counterclockwise direction), the driving force (e.g., rotational force) of the driving motor 320 may rotate the bushing 330 coupled to a rotation axis of the driving motor 320 in the second direction (e.g., counterclockwise direction). The rotation of the bushing 330 may move the transmission 340 connected to the bushing 330 in the front direction F. The transmission 340 may receive rotational force from the bushing 330 and move toward the outside (e.g., the front direction F) of the first space S1 of the bushing 330 while rotating along the third thread 373 of the second spindle 370. In case that the transmission 340 rotates in the first direction (e.g., clockwise direction), the second spindle 370 is in a fixed state, and the lead screw 341 of the transmission 340 may move by the second length D2 of the second spindle 370. Since the second spindle 370 is in a fixed state, the first spindle 360 and the transfer block 350 interlocked therewith may be in a fixed state without moving or rotating.

As the shaft portion 342 extending from a rear end of the lead screw 341 of the transmission 340 moves in the front direction F in the first space S1 of the bushing 330, the state may be converted to a state in which power between the transmission 340 and the second spindle 370 is interrupted (e.g., the clutch disengagement state). Accordingly, the door 50 is in a state in which the manual mode (and automatic mode) is possible, so that the user may manually close the door 50.

According to an embodiment, in the open state of the door 50 (e.g., the state C), the nut 351 of the transfer block 350 disposed on the first spindle 360 is in a state of being moved toward the door side (e.g., the front direction F), and the lead screw 341 of the transmission 340 may also be in a state of being moved toward the door side (e.g., the front direction F). In the open state of the door 50 (e.g., the state C), the nut 351 of the transfer block 350 and the lead screw 341 of the transmission 340 may be disposed to be more spaced apart than in the closed state of the door 50 (e.g., the state A). For example, the nut 351 of the transfer block 350 may be in a state of being adjacent to a front side end of the first spindle 360. For example, the lead screw 341 of the transmission 340 may be in a state of being in contact with or adjacent to (e.g., closely spaced from) a front side end of the second spindle 370. For example, a distance between the nut 351 of the transfer block 350 and the lead screw 341 of the transmission 340 may be a distance equal to or greater than the first length D1.

According to an embodiment, the opening operation of the door 50 in the automatic mode of the door 50 (e.g., proceeding in the order of the state C, the state D, and the state A) is described.

According to an embodiment, in the open state of the door 50 (e.g., the state C), the nut 351 of the transfer block 350 disposed on the first spindle 360 is in a state of being moved toward the door side (e.g., the front direction F), and the lead screw 341 of the transmission 340 may also be in a state of being moved toward the door side (e.g., the front direction F). In the open state of the door 50 (e.g., the state C), the nut 351 of the transfer block 350 and the lead screw 341 of the transmission 340 may be disposed to be more spaced apart than in the closed state of the door 50 (e.g., the state A). For example, the nut 351 of the transfer block 350 may be in a state of being adjacent to a front side end of the first spindle 360. For example, the lead screw 341 of the transmission 340 may be in a state of being in contact with or adjacent to (e.g., closely spaced from) a front side end of the second spindle 370. For example, a distance between the nut 351 of the transfer block 350 and the lead screw 341 of the transmission 340 may be a distance equal to or greater than the first length D1.

According to an embodiment, in case that the driving motor 320 operates and rotates in the second direction (e.g., counterclockwise direction), the driving force (e.g., rotational force) of the driving motor 320 may rotate the bushing 330 coupled to a rotation axis of the driving motor 320 in the second direction (e.g., counterclockwise direction). The rotation of the bushing 330 may rotate the transmission 340 connected to the bushing 330 in the first direction (e.g., clockwise direction). The lead screw 341 of the transmission 340 is positioned at a front side end of the second spindle 370 (e.g., the clutch engagement state), and may transmit sufficient rotational force to the second spindle 370, and accordingly, the second spindle 370 may rotate in the second direction (e.g., counterclockwise direction). For example, the transmission 340 is in a state in which it may not move further in the front direction F, and is in a state in which only rotational motion is possible without linear motion (e.g., the clutch engagement state), so that the rotational force received from the bushing 330 may be completely transmitted to the second spindle 370.

In case that the second spindle 370 rotates in the second direction (e.g., counterclockwise direction), the first spindle 360 interlocked (e.g., fixedly coupled) with the second spindle 370 may rotate in the same second direction (e.g., counterclockwise direction) as the second spindle 370. The rotation of the first spindle 360 may move the nut 351 of the transfer block 350 screw-coupled to the first thread 361 of the first spindle 360 in the rear direction R. The nut 351 of the transfer block 350 may move by the first length D1 of the first spindle 360.

The movement of the transfer block 350 in the rear direction R may pull the door 50 to proceed with the closing operation of the door 50. For example, the rear side movement of the nut 351 of the transfer block 350 may move the push rod 352 coupled to the nut 351 in the rear direction R and close the door 50 coupled to the push rod 352.

According to an embodiment, in one state (e.g., the state D) of the closed state of the door 50, the nut 351 of the transfer block 350 disposed on the first spindle 360 is in a state of being moved toward the driving motor side (e.g., the rear direction R), and the lead screw 341 of the transmission 340 may be in a state of being moved toward the door side (e.g., the front direction F). In one state (e.g., the state D) of the closed state of the door 50, since the transmission 340 is in a state in which it is engaged with the second spindle 370 to enable power transfer (e.g., the clutch engagement state), the door 50 may be in a state in which the manual mode is not possible. Therefore, in order for the user to easily manually open or close the door, it is necessary to convert to a state in which power between the transmission 340 and the second spindle 370 is interrupted (e.g., the clutch disengagement state).

In order to switch to a state in which the manual mode (and automatic mode) of the door 50 is possible (e.g., the state D to the state A), the home appliance 1 may perform the following additional operation.

According to an embodiment, in case that the driving motor 320 operates and rotates in the first direction (e.g., clockwise direction), the driving force (e.g., rotational force) of the driving motor 320 may rotate the bushing 330 coupled to a rotation axis of the driving motor 320 in the first direction (e.g., clockwise direction). The rotation of the bushing 330 may move the transmission 340 connected to the bushing 330 in the rear direction R. The transmission 340 may receive rotational force from the bushing 330 and move toward the inside (e.g., the rear direction R) of the first space S1 of the bushing 330 while rotating along the third thread 373 of the second spindle 370. In case that the transmission 340 rotates in the second direction (e.g., counterclockwise direction), the second spindle 370 is in a fixed state, and the lead screw 341 of the transmission 340 may move by the second length D2 of the second spindle 370. Since the second spindle 370 is in a fixed state, the first spindle 360 and the transfer block 350 interlocked therewith may be in a fixed state without moving or rotating.

As the shaft portion 342 extending from a rear end of the lead screw 341 of the transmission 340 moves in the rear direction R in the first space S1 of the bushing 330, the state may be converted to a state in which power between the transmission 340 and the second spindle 370 is interrupted (e.g., the clutch disengagement state). Accordingly, the door 50 is in a state in which the manual mode (and automatic mode) is possible, so that the user may manually open the door 50.

According to an embodiment, in the closed state of the door 50 (e.g., the state A), the nut 351 of the transfer block 350 disposed on the first spindle 360 is in a state of being moved toward the driving motor side (e.g., the rear direction R), and the lead screw 341 of the transmission 340 may also be in a state of being moved toward the driving motor side (e.g., the rear direction R). In the closed state of the door 50 (e.g., the state A), the nut 351 of the transfer block 350 and the lead screw 341 of the transmission 340 may be disposed to be spaced apart. For example, the nut 351 of the transfer block 350 may be in a state of being adjacent to (e.g., closely spaced from) a rear side end of the first spindle 360. For example, the lead screw 341 of the transmission 340 may be in a state of being adjacent to a rear side end of the second spindle 370 or in a state of being in contact with or adjacent to (e.g., closely spaced from) the bushing 330. For example, a distance between the nut 351 of the transfer block 350 and the lead screw 341 of the transmission 340 may be a distance equal to or greater than the second length D2.

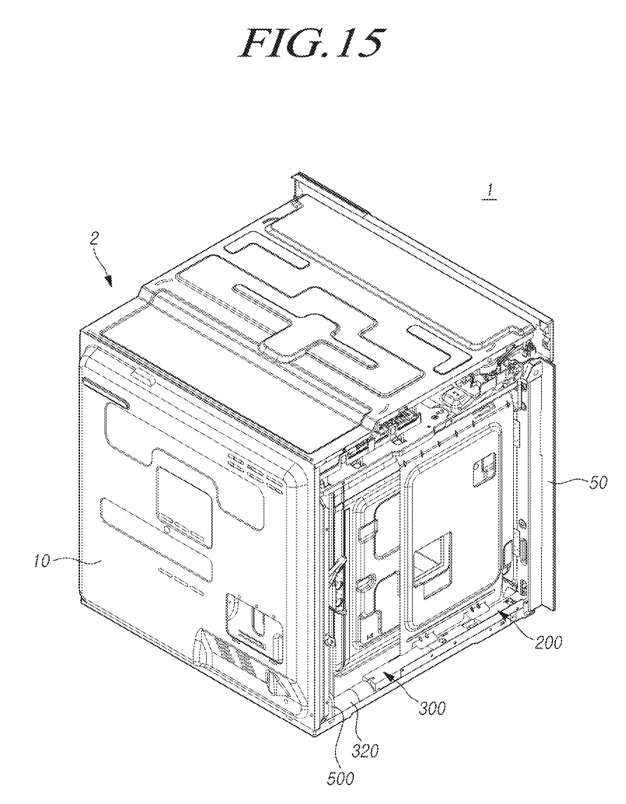

FIG. 15 is a perspective view illustrating a door driving module, a hinge module, and a circuit board disposed in a home appliance according to an embodiment of the disclosure.

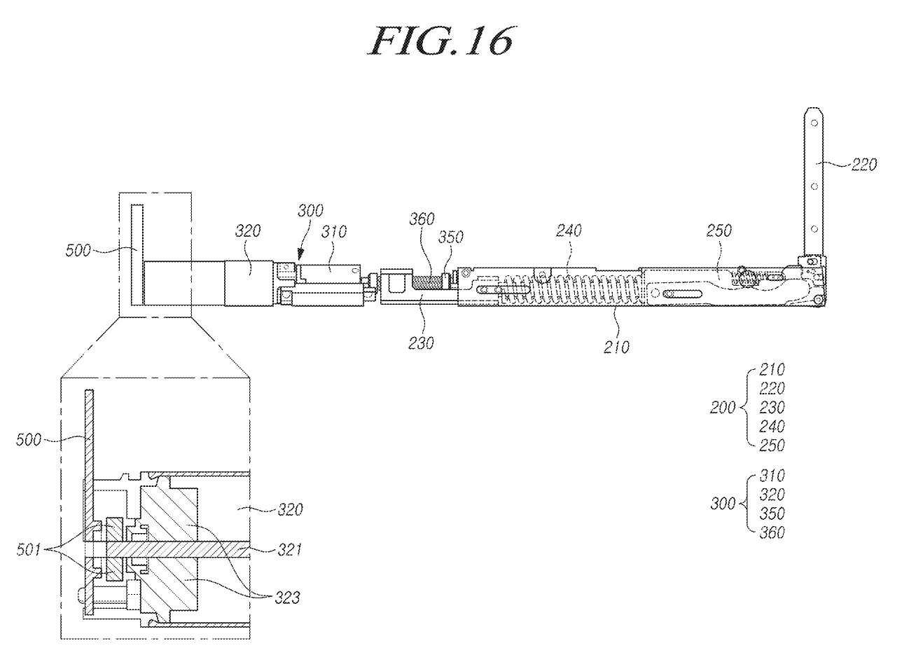

FIG. 16 is a view illustrating a door driving module, a hinge module, and a circuit board in a transparent manner, according to an embodiment of the disclosure.

According to an embodiment, the home appliance 1 (e.g., a cooking device) may include the main body 2, the door 50, the hinge module 200, the door driving module 300, and a circuit board 500. The main body 2 may include the housing 10 and components disposed in the housing 10. The main body 2 may be configured to have a front opened by the door 50. The door 50 is rotatably connected to the main body 2 and may open or close the cooking chamber (e.g., the cooking chamber 21 of FIGS. 1-3) of the main body 2. The hinge module 200 may connect the door 50 to be rotatable about the main body 2.

According to an embodiment, the door driving module 300 is connected to the hinge module 200 and may configure the door 50 to be opened or closed in the automatic mode or the manual mode with respect to the main body 2.

The configurations of the housing 10, the door 50, the door driving module 300, and the hinge module 200 of FIGS. 15 and 16 may be identical or similar to the configurations of the housing 10, the door 50, the door driving module 300, and the hinge module 200 of FIGS. 1-14B.

The embodiments of FIGS. 15 and 16 may be selectively combined with the embodiments of FIGS. 1 to 14B and 17-21.

According to an embodiment, the home appliance 1 may include the hinge module 200, the door driving module 300, and the circuit board 500 arranged along a lower edge of one side or two opposite sides of the main body 2 (or the housing 10).

According to an embodiment, the hinge module 200 may connect the door 50 to be rotatable about the main body 2. The hinge module 200 is connected to the door driving module 300 and may transmit a force received from the door driving module 300 to the door 50. The hinge module 200 may include the hinge body 210, the rotation lever 220, the elastic lever 230, an elastic body 240, and/or a damper 250.

According to an embodiment, the hinge body 210 may support the door 50 to be rotatable about the main body 2 and transmit a force received from the door driving module 300 to the door 50. For example, the hinge body 210 may guide an open or close operation of the door 50 based on a hinge axis.

According to an embodiment, the rotation lever 220 is an arm-shaped component rotatably coupled to the hinge body 210, one side of which is connected to the hinge body 210 and the other side of which may be coupled to the door 50. For example, in the automatic mode of the door 50, the rotation lever 220 may receive a driving force transmitted to the door driving module 300 and directly provide force to the door 50. In the manual mode of the door 50, the rotation lever 220 may receive a force from the user and rotate the door 50 with respect to the hinge body 210.

According to an embodiment, the elastic lever 230 is a lever structure providing tension, one side of which is connected to the hinge body 210 and the other side of which may be coupled to the door driving module 300. The elastic lever 230 may stabilize the position of the door 50 or support a return operation (e.g., a closing operation of the door 50) using energy of the elastic body 240 (e.g., a spring). In the automatic mode or the manual mode of the door 50, the elastic lever 230 may transmit a force generated by the door driving module 300 or a force applied from the door 50 to the opposite side, and absorb an impact applied in addition to a necessary force.

According to an embodiment, the elastic body 240 is disposed in an inner space of the hinge body 210 and/or between the rotation lever 220 and the elastic lever 230 and may provide a restoring force corresponding to a weight of the door 50. For example, in case that the door 50 is opened, the elastic body 240 is compressed to store energy and, in case that the door 50 is closed, the stored energy is released to provide a force that returns the door 50 toward the main body 2.

According to an embodiment, the elastic body 240 may alleviate lowering of the door 50 due to its own weight and reduce a force required for the user to open or close the door 50. The elastic body 240 may be combined with the driving force of the door driving module 300 to control an opening/closing speed of the door 50 or to maintain an opening/closing angle constant.

According to an embodiment, the damper 250 is connected to the elastic body 240 in the hinge body 210 and may absorb an impact or vibration generated in case that the door 50 is opened or closed. For example, in case that the door 50 is closed at a high speed, the damper 250 may gradually decelerate a rotation speed of the door 50 using a hydraulic or viscous resistance structure, thereby reducing an impact and an impact noise that may be generated in case that the door 50 collides with the main body 2.

According to an embodiment, the damper 250 may provide a constant resistance in case that the door 50 is opened to control the door 50 from being excessively opened. Accordingly, the hinge module 200 may maintain the opening/closing operation of the door 50 more smoothly and quietly, and simultaneously enhance user safety and durability.

According to an embodiment, the door driving module 300 may include the case 310, the driving motor 320, the bushing 330, the transmission 340, the transfer block 350, the first spindle 360, the second spindle 370, and/or the cover 380. The door driving module 300 may be disposed on one side (e.g., an inner surface of the outer case 12 of the housing 10) of the main body 2. The door driving module 300 is connected to the hinge module 200 and may be disposed on one side or two opposite sides of the door 50.

The door driving module 300 is disposed adjacent to a lower surface of the outer case 310, but this is not limited thereto, and the position of the door driving module 300 may be easily changed in various regions of the main body 2 or the door 50 for convenient driving of the door 50.

According to an embodiment, the circuit board 500 may be disposed at a rear end (back end) of the driving motor 320, which is one side (e.g., a direction opposite to the bushing 330) of the driving motor 320. A Hall sensor 501 for sensing a rotation speed of the driving motor 320 may be disposed (or mounted) on the circuit board 500. In case that a magnet 323 press-fitted to a rear end of a motor shaft 321 rotates, the Hall sensor 501 may be configured to sense the rotation speed by detecting a polarity change of the magnet 323.

According to an embodiment, the Hall sensor 501 disposed (or mounted) on the circuit board 500 may be disposed to detect a magnetic field change of the magnet 323 coupled to the motor shaft 321 of the driving motor 320. For example, the Hall sensor 501 is located on a front surface (a magnetic field application surface) of the circuit board 500 so as to face a rotation center axis of the magnet 323, and a gap between the Hall sensor 501 and the magnet 323 may be designed to be maintained at an interval suitable for a magnetic field sensing characteristic.

According to an embodiment, the magnet 323 of the driving motor 320 may be a circumferential ring magnet disposed in a circumferential direction of the motor shaft 321 or a disc-shaped magnet magnetized in an axial direction. The Hall sensor 501 may be disposed to be aligned with the magnet 323. The magnet 323 may be fixed to the motor shaft 321 without being detached by a key groove coupling, a snap ring coupling, an adhesive coupling, or a fitting coupling.

According to an embodiment, the circuit board 500 may include a control circuit (e.g., a microcontroller, a driving IC) and the Hall sensor 501. The control circuit may calculate a rotation speed and/or a rotation amount of the driving motor 320 by counting a pulse signal output from the Hall sensor 501, and may calculate a linear movement amount of the first spindle 360 and/or the second spindle 370 of the transfer block 350 based on the result. Accordingly, the control circuit may indirectly calculate an opening/closing angle of the door 50, and may decelerate or stop the driving of the driving motor 320 in case of reaching a target angle to implement a smooth opening/closing operation.

According to an embodiment, the Hall sensor 501 may have a single channel or a two-channel quadrature configuration. In the case of the two-channel configuration, the control circuit may determine a rotation direction of the motor using a phase difference and enhance position estimation accuracy in a driving or return section.

According to an embodiment, the circuit board 500 may further include a current detection circuit to monitor a driving current of the driving motor 320 in real-time. The control circuit may determine a stall state by simultaneously detecting a pulse frequency of the Hall sensor 501 and an increase in the driving current, and may quickly cut off or reverse an output of the driving motor 320 to limit (e.g., reduce or prevent) mechanism damage.

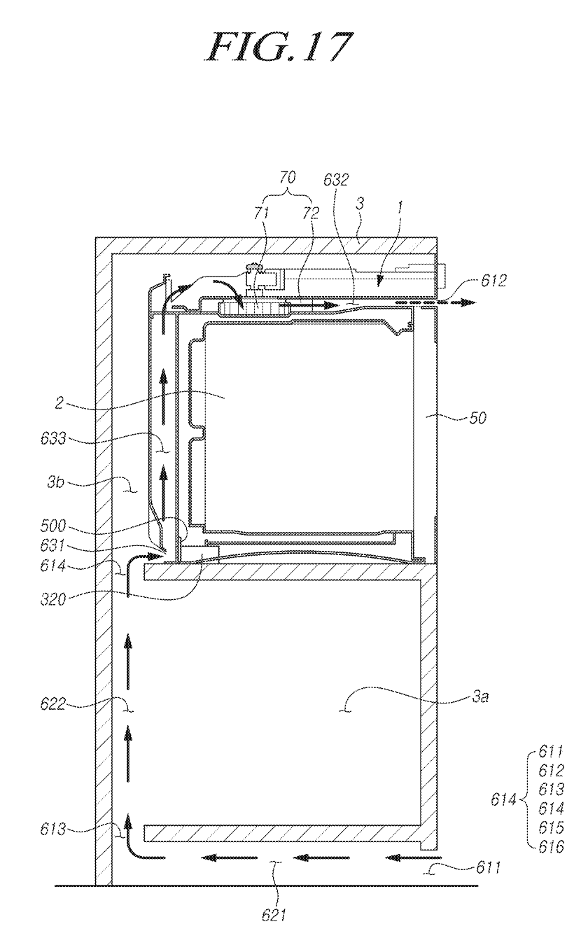

According to an embodiment, the circuit board 500 is a component vulnerable to heat, and may be designed so as not to be located in a high-temperature region (e.g., a region of about 100°C or higher) or may be disposed in a region where air (e.g., outdoor air) circulation is smooth. For example, since some regions of the main body 2 on which the circuit board 500 is disposed may become a high-temperature environment, by adjusting a fan motor (e.g., the blower device 70 of FIG. 17) and a flow path shape of a surrounding structure, the circuit board 500 may be designed to be located in a region where outdoor air circulation is smooth so as not to be overheated.

Hereinafter, a heat dissipation structure (e.g., an outdoor air circulation structure) around the circuit board 500 is specifically described.

FIG. 17 is a view illustrating a home appliance disposed in a furniture cabinet and an outdoor air circulation structure according to an embodiment of the disclosure.

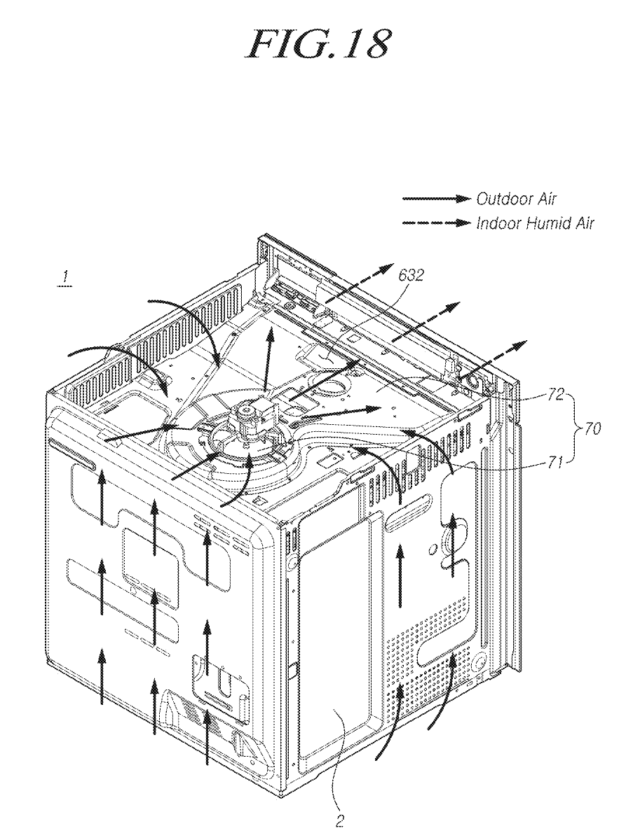

FIG. 18 is a perspective view illustrating outdoor air circulating through a blower device of a home appliance according to an embodiment of the disclosure.

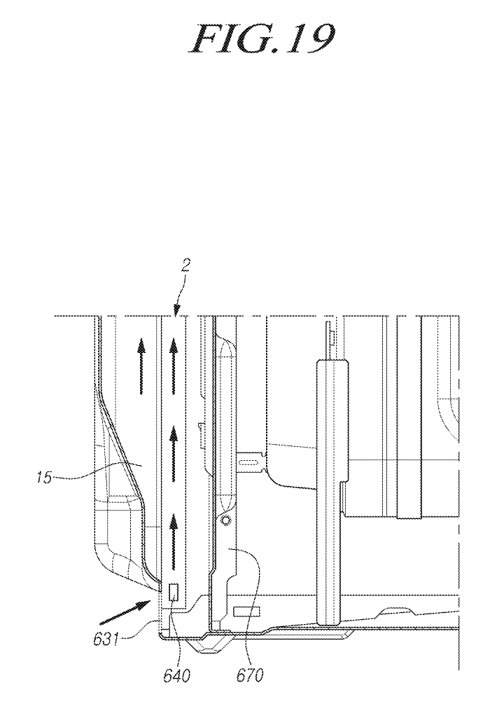

FIG. 19 is a perspective view illustrating an outdoor air circulation structure around a circuit board of a home appliance according to an embodiment of the disclosure.

According to an embodiment, the home appliance 1 (e.g., a cooking device) may include the main body 2, the door 50, a hinge module (e.g., the hinge module 200 of FIGS. 15 and 16), a door driving module (e.g., the door driving module 300 of FIGS. 15 and 16), and a circuit board (e.g., the circuit board 500 of FIGS. 15 and 16).

The structure of the home appliance 1 of FIGS. 17-19 may be identical or similar to the structure of the home appliance 1 of FIGS. 1-16. The embodiments of FIGS. 17-19 may be selectively combined with the embodiments of FIGS. 1-16, 20 and 21.

According to an embodiment, the door driving module 300 is connected to the hinge module 200 and may configure the door 50 to be opened or closed in the automatic mode or the manual mode with respect to the main body 2.

According to an embodiment, the home appliance 1 may be disposed in a furniture cabinet 3. In general, among the home appliances 1, a dish washer or a cooking device (e.g., an oven) is installed in a built-in manner inside the furniture cabinet 3, thereby maintaining a beautiful kitchen design. Further, by locating the dish washer or the cooking device in the furniture cabinet 3, space utilization may be increased, and by being disposed adjacent to water supply pipes, connection of drainage and water supply may be facilitated. According to an embodiment, the furniture cabinet 3 may be formed to have a front open of the home appliance 1 for opening of a door, and configured to surround sides, an upper surface, and a portion of a rear surface of the home appliance 1.

According to an embodiment, in case that the home appliance 1 is disposed in the furniture cabinet 3, the home appliance 1 may be disposed at a location (e.g., a second level portion 3b) raised by a designated distance from the ground for user convenience. For example, the furniture cabinet 3 may include a first level portion 3a spaced apart from the ground, and the second level portion 3b disposed on the first level portion 3a and on which the home appliance 1 may be seated.

According to an embodiment, a flow path structure 600 for outdoor air circulation to reduce (e.g., lower) heat generated from the home appliance 1 may be formed in the furniture cabinet 3. The flow path structure 600 of the furniture cabinet 3 includes a first opening 611 for receiving outdoor air and a second opening 612 for discharging outdoor air, and may be a structure in which outdoor air introduced into an inside of the furniture cabinet 3 through the first opening 611 circulates along a plurality of connected flow paths and is then discharged to the outside through the second opening 612. For example, the flow path structure 600 of the furniture cabinet 3 may include the first opening 611 formed in a region adjacent to the ground and configured to introduce outdoor air, a first flow path 621 formed at a lower portion of a first level region 3a and providing a path through which outdoor air may move, and a second flow path 622 connected to the first flow path 621 and formed so that outdoor air moves from the first level portion 3a to the second level portion 3b after passing through the first flow path 621. The flow path structure 600 of the furniture cabinet 3 may include a third opening 613 for connection from the first flow path 621 to the second flow path 622 and a fourth opening 614 connecting the first level portion 3a and the second level portion 3b.

According to an embodiment, outdoor air passing through the second flow path 622 may be introduced into an inlet 631 disposed on a lower surface side of the home appliance 1, then move upward along a passage 632 formed on a rear surface of the home appliance 1, and be discharged to the outside through the blower fan 71.

According to an embodiment, the circuit board 500 disposed at a rear end (back end) of the driving motor 320 in the home appliance 1 is a component vulnerable to heat, and may be deformed or damaged in case of being exposed to high heat. Accordingly, the circuit board 500 is disposed on one side of the driving motor 320 in terms of position, but as outdoor air is introduced around the circuit board 500 and natural convection is formed, the circuit board 500 may be stably protected from heat without a separate cooling structure. For example, the circuit board 500 may apply a material with relatively low heat resistance and still stably implement product performance, thereby obtaining an effect of reducing overall material costs.

According to an embodiment, the home appliance 1 may include a structure for circulating (e.g., upwardly flowing) outdoor air around the circuit board 500. The outdoor air circulation structure may be configured to introduce outdoor air through the inlet 631 at a lower portion of the furniture cabinet 3 or a lower front portion of the home appliance 1, guide outdoor air from a lower portion to an upper portion through a third flow path 633 formed along a rear wall of the home appliance 1, and transfer the outdoor air of the third flow path 633 to an upper duct by the blower device 70 disposed on an upper side of the home appliance 1, and then discharge the outdoor air through a front (or upper) outlet 632 of the home appliance 1.

According to an embodiment, the circuit board 500 is disposed at a portion adjacent to the third flow path 633 in a rear end region of the driving motor 320 and is directly exposed to outdoor air flowing upward, so that the circuit board 500 may be stably cooled without adding a separate cooling device (e.g., a heat sink or a cooling channel). A temperature measurement unit 640 is disposed adjacent to a lower inlet 631 of the third flow path 633 or the circuit board 500, and may monitor an outdoor air temperature and a component (e.g., circuit board 500) temperature and control driving of the blower device 70.

According to an embodiment, a flow of outdoor air may be formed by forced convection induced by a suction force of the blower fan 71 of the blower device 70. The outdoor air may pass through only around the circuit board 500 along a path separate from moisture or heat generated in the cooking chamber and then be discharged to the outside. Accordingly, a high-temperature portion (e.g., a region of about 100°C or higher) and a cooling flow path of the circuit board 500 are thermally separated from each other, so that the temperature of the circuit board 500 may be maintained so as not to approach a heat resistance limit.

According to an embodiment, the home appliance 1 may include the blower device 70 capable of cooling the electrical component chamber 40 by circulating air around the electrical component chamber (e.g., the electrical component chamber 40 of FIG. 3) and an insulating cover (cover adiabatic rear) 670 covering an insulator disposed in the rear panel 15 of the housing 10.

According to an embodiment, the blower device 70 may include the blower fan 71 flowing air and the discharge flow path 72 (e.g., a duct) provided to discharge air sucked by the blower fan 71 to the front of the home appliance 1. The blower fan 71 of the blower device 70 may suck air in an axial direction and then discharge the air in a radial direction.

According to an embodiment, through the blower device 70, air (e.g., outdoor air) of the third flow path 633 formed through the rear panel 15 and the insulating cover 670 may be sucked toward the discharge flow path 72 and discharged to the outside of the home appliance 1.

According to an embodiment, the insulating cover 670 is disposed between the rear panel 15 of the home appliance 1 and a cooking chamber rear wall (high-temperature portion) and may limit (e.g., block) radiant heat or conduction heat generated from the cooking chamber from being transmitted to the electrical component chamber 40 and the circuit board 500 at a rear portion. The insulating cover 670 may be formed of, e.g., a metal plate, a heat-resistant resin plate, or a composite material plate having a heat insulating coating layer formed thereon. The insulating cover 670 is spaced apart from the rear panel 15 with a predetermined gap therebetween, so that a space therebetween may be formed as the third flow path 633 through which cooling outdoor air moves.

According to an embodiment, the third flow path 633 is an upward flow path formed between the rear panel 15 and the insulating cover 670, and may be configured so that outdoor air introduced through the inlet 631 at a bottom portion of the home appliance 1 moves from a lower portion to an upper portion direction along the third flow path 633. The introduced outdoor air may pass through the third flow path 633 and flow along surfaces of a rear end portion of the driving motor 320 and the circuit board 500 disposed in the vicinity thereof to absorb heat, then be sucked by the blower device 70 at an upper end portion, and be discharged to the outside through the duct 72.

According to an embodiment of the disclosure, the insulating cover 670 and the rear panel 15 may form a cooling flow path (e.g., the third flow path 633) through which outdoor air may circulate while blocking heat from the high-temperature portion, thereby allowing the circuit board 500 to be stably maintained even in a high-temperature environment. A reflective layer or an insulator layer reflecting radiant heat may be further formed on an inner surface of the insulating cover 670 to limit a temperature rise of outdoor air passing through the third flow path 633 and enhance cooling efficiency.

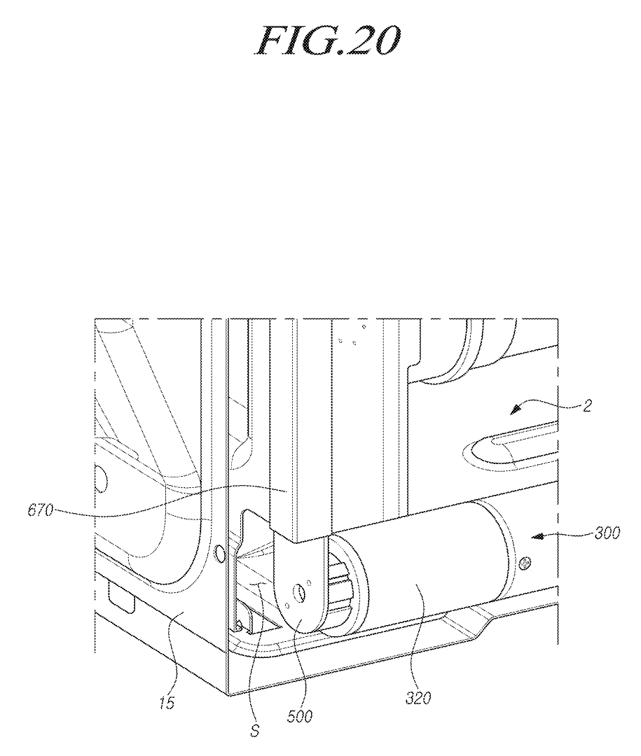

FIG. 20 is a view illustrating an insulating cover and a circuit board in a home appliance according to an embodiment of the disclosure.

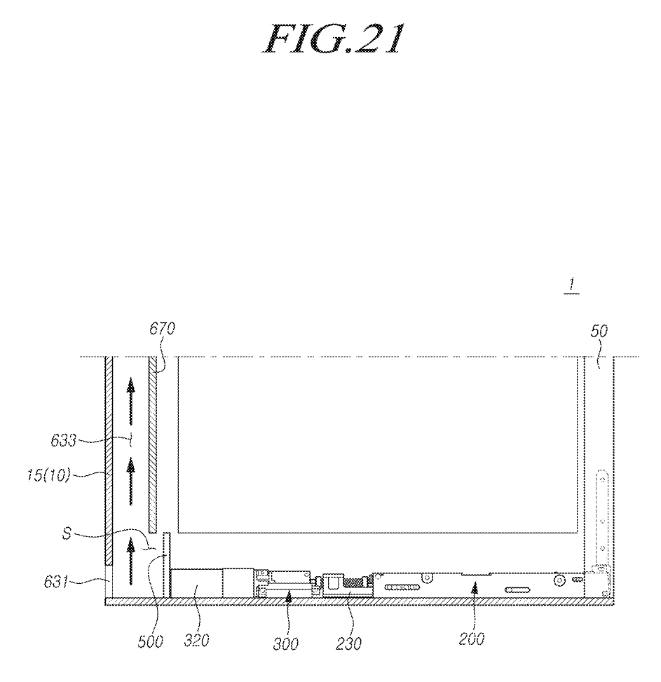

FIG. 21 is a view illustrating a cross-section of an insulating cover and a circuit board in a home appliance according to an embodiment of the disclosure.

According to an embodiment, the home appliance 1 (e.g., a cooking device) may include the main body 2, the door 50, the hinge module 200, the door driving module 300, and a circuit board 500.

The structure of the home appliance 1 of FIGS. 20 and 21 may be identical or similar to the structure of the home appliance 1 of FIGS. 1-19. The embodiments of FIGS. 20 and 21 may be selectively combined with the embodiments of FIGS. 1-19.

According to an embodiment, the door driving module 300 is connected to the hinge module 200 and may configure the door 50 to be opened or closed in the automatic mode or the manual mode with respect to the main body 2.

According to an embodiment, the home appliance 1 may include a blower device (e.g., the blower device 70 of FIG. 18) and the insulating cover (cover adiabatic rear) 670 covering an insulator disposed in the rear panel 15 of the housing 10. The third flow path 633 is a space between the rear panel 15 and the insulating cover 670, and may provide a path through which outdoor air introduced through the rear panel 15 is directed toward the blower device 70. The circuit board 500 is located on one side of the third flow path 633, and outdoor air may cool the circuit board 500 and surrounding components to alleviate (e.g., reduce) a thermal rise of the circuit board 500. For example, before the third flow path 633 is generated, in case that the driving motor 320 is driven, a temperature of the circuit board 500 and surrounding components may be about 100°C or higher (e.g., 120°C). In case that the third flow path 633 is generated and the circuit board 500 and surrounding components are cooled by outdoor air circulation, a temperature of the circuit board 500 and surrounding components may be about 50°C to 60°C.

According to an embodiment, in order for outdoor air moving through the third flow path 633 to further cool the circuit board 500 and surrounding components, one side of the insulating cover 670 adjacent to the circuit board 500 may be opened. For example, a lower portion of the insulating cover 670 is opened (e.g., an outdoor air hole S is formed) along a lower edge of the rear panel 15 so that outdoor air passes through the rear panel 15 and is introduced into an inside, and then guides the outdoor air to enter the third flow path 633. The outdoor air hole S extends to a region where the circuit board 500 and a rear end portion of the driving motor 320 are located, so that the introduced outdoor air may move directly toward the circuit board 500. Accordingly, the insulating cover 670 may thermally block a high-temperature portion while simultaneously providing a passage (e.g., the outdoor air hole S) through which cooling air may pass, thereby performing a function of forming a cooling flow path and a heat shielding function at the same time.

According to an embodiment, an inner surface of the insulating cover 670 may be surface-treated so as not to reflect or absorb heat radiated from a cooking chamber rear wall. For example, the insulating cover 670 may include a metal plating layer or a heat-resistant coating layer reflecting radiant heat to suppress radiant heat from a cooking chamber high-temperature portion from affecting a temperature of outdoor air rising along the third flow path 633.

According to an embodiment, the insulating cover 670 and the rear panel 15 are fixed while maintaining a constant distance from each other to guide outdoor air to uniformly move along the third flow path 633. The constant distance may be formed so that structural rigidity of the insulating cover 670 is maintained while outdoor air may smoothly move from a lower portion to an upper portion according to a suction force of the blower device 70. The structure may limit (e.g., suppress) heat accumulation inside the home appliance 1 by efficiently cooling the circuit board 500 and surrounding components by outdoor air passing through the third flow path 633.

According to an embodiment, a shape or length of the elastic lever 230 of the hinge module 200 may be designed to adjust a relative position between the door driving module 300 and other components of the hinge module 200. According to adjustment of the elastic lever 230, an installation position of the circuit board 500 coupled to the rear end of the driving motor 320 may be disposed to be adjacent to the third flow path 633. Accordingly, the circuit board 500 may be disposed at a position capable of directly exchanging heat with outdoor air rising along the third flow path 633.

According to an embodiment, in case that the circuit board 500 is disposed in close proximity to the third flow path 633, convective cooling efficiency may be enhanced as outdoor air flows along a surface of the circuit board 500. In this case, a flow of outdoor air may rapidly lower heat by passing around heat generating components (e.g., a motor control IC or a Hall sensor) of the circuit board 500.

A home appliance (e.g., a cooking device) may include a driving module for automatically or manually opening or closing a door. In general, a clutch structure in the driving module may have an overall size of the driving module increased due to a movement distance required for a door or a transfer block connected thereto to switch a door state from a door open state (or a door closed state) to a door closed state (or a door open state) in the manual mode and a slot structure for receiving the same.

A home appliance (e.g., a cooking device) according to an embodiment of the disclosure may provide a compact door driving module for automatically or manually opening or closing a door.

A door driving module of a home appliance according to an embodiment of the disclosure may include a first spindle and a second spindle, each forming a thread and interlocked with each other. The first spindle and the second spindle may be manufactured with different leads, thereby designing a movement distance of a transmission performing linear motion guided by the second spindle to be smaller than a movement distance of a transfer block performing linear motion guided by the first spindle. Accordingly, a compact door driving module may be provided.

A door driving module of a home appliance according to an embodiment of the disclosure may include a clutch structure. The clutch structure may implement a structure interlocked with rotational motion to provide a door driving module providing a strong force with a small size.

A home appliance according to an embodiment of the disclosure may effectively limit (e.g., suppress) a temperature rise of a circuit board having low heat resistance by circulating cooling air through an outdoor air flow passage formed between a rear panel and an insulating cover. Accordingly, the circuit board and surrounding electronic components may be stably driven even in a high-temperature environment, and heat accumulation may be minimized without adding a separate cooling structure or heat dissipation device.

A home appliance according to an embodiment of the disclosure may enhance cooling efficiency by the insulating cover blocking radiant heat from a high-temperature portion and disposing an outdoor air flow. Accordingly, the home appliance may simultaneously secure an electrical component chamber cooling function and a door driving function without increasing structural complexity, and may provide product reliability enhancement, weight reduction, and cost reduction.

Effects that may be obtained from the disclosure are not limited to the above-mentioned effects, and other effects not mentioned may be clearly understood by those skilled in the art to which the disclosure belongs from the following description.

A home appliance 1 according to an embodiment of the disclosure may include a main body 2 having an open front, a door 50 rotatably connected to the main body, and a door driving module 300 configured to open or close the door in an automatic mode or a manual mode with respect to the main body. The door driving module 300 may include a driving motor 320 configured to generate rotational force, a transmission 340 configured to receive the rotational force from the driving motor, a bushing 330 coupled with the driving motor 320 and the transmission 340 such that the rotational force generated from the driving motor 320 transmits to the transmission 340, and defining a space in which the transmission is movable in a front-rear direction, a transfer block 350 configured to move in the front-rear direction in response to an opening operation or a closing operation of the door 50 in the automatic mode or the manual mode, a first spindle 360 configured to guide movement of the transfer block 350 in the front-rear direction such that the first spindle rotates in response to the opening operation or the closing operation of the door 50, and a second spindle 370 configured to guide the movement of the transmission 340 in the front-rear direction such that the second spindle 370, having a front end coupled to the first spindle 360, rotates in conjunction with the rotation of the first spindle 360.

According to an embodiment, in the automatic mode of the door, the transmission 340 may be configured to transfer the rotational force received from the driving motor 320 to the second spindle 370.

According to an embodiment, in the manual mode of the door, the transmission 340 may be configured to move in the front-rear direction within the space of the bushing 330 based on the rotational force received from the second spindle 370.

According to an embodiment, the first spindle 360 may include a first thread 361 arranged along an outer surface thereof, and the second spindle 370 may include a second thread 371 arranged along an inner surface thereof. A first length D1 along the first spindle, the first length being a distance by which a nut of the transfer block 350 travels between the open state and the closed state in the front-rear direction, may be greater than a second length D2 along the second spindle, the second length being a distance by which a lead screw of the transmission 340 travels between the open state and the closed state in the front-rear direction.

According to an embodiment, a first thread 361 of the first spindle 360 has a first lead, and a second thread 371 of the second spindle 370 has a second lead smaller than the first lead, such that a linear movement distance of the transfer block 350 may be greater than a linear movement distance of the transmission 340.

According to an embodiment, the bushing 330, the transmission 340, and the second spindle 370 may be configured to form a clutch structure. The door driving module may be configured to operate in a clutch engagement state in which the transmission 340 is engaged with the second spindle 370 so as to enable power transfer to the first spindle 360, and a clutch disengagement state in which power transfer between the transmission 340 and the second spindle 370 is interrupted.

According to an embodiment, in the clutch engagement state, a front end of the transmission 340 may be disposed adjacent to a front end of an inner space of the second spindle 370, or a rear end of the transmission 340 may be disposed adjacent to a rear end of the space of the bushing 330. The transmission 340 may be configured to rotate based on the rotational force received from the bushing 330 such that the transmission 340 rotates the second spindle 370.

According to an embodiment, the first spindle 360 having a first thread 361 and the second spindle 370 having a second thread 371 may be each arranged such that the first spindle 360 and the second spindle 370 rotate in a first direction.

According to an embodiment, in a closed state of the door, the transmission 340 may be located closer to the door 50 within the space of the bushing 330, and in an open state of the door, the transmission 340 may be located closer to the driving motor 320 within the space of the bushing 330.

According to an embodiment, the first spindle 360 having a first thread 361 may be configured to rotate in a first direction, and the second spindle 370 having a second thread 371 may be configured to rotate in a second direction opposite to the first direction.

According to an embodiment, in a closed state of the door 50, the transmission 340 may be located to the driving motor 320 within the space of the bushing 330, and in an open state of the door 50, the transmission 340 may be located closer to the door 50 within the space of the bushing 330.

According to an embodiment, in the manual mode of the door 50, the opening operation or the closing operation of the door 50 may be configured such that the transfer block 350 moves in the front-rear direction in response to the opening operation or the closing operation of the door 50 by an external force applied to the door 50, and thereby rotates the first spindle 360 and the second spindle 370 coupled to each other, and the transmission 340 may be configured to move in the front-rear direction within the space of the bushing 330.

According to an embodiment, in the automatic mode of the door, the driving motor 320 may be configured to transmit the rotational force generated from the driving motor 320 through the transmission 340 to the second spindle 370 and the first spindle 360 coupled to each other. The transfer block 350 configured to move in the front-rear direction along a first thread 361 of the first spindle 360 may perform the opening operation or the closing operation of the door.

According to an embodiment, in the manual mode of the door, the transfer block 350 may be configured to move in a forward direction toward the door in response to the opening operation of the door by an external force applied to the door such that the transfer block rotates the first spindle 360 and the second spindle 370 coupled to each other in a first direction, and the transmission 340 may be configured to move toward the driving motor 320 within the space of the bushing 330.

According to an embodiment, in the manual mode of the door, the transfer block 350 may be configured to move in a rearward direction toward the driving motor 320 in response to the closing operation of the door 50 by an external force applied to the door such that the transfer block 350 may rotate the first spindle 360 and the second spindle 370 coupled to each other in a second direction opposite to a first direction, and the transmission 340 may be configured to move toward the door 50 within the space of the bushing 330.

According to an embodiment, in the automatic mode of the door, the transmission 340 is configured to first move toward the door 50, and then rotate in a first direction resulting from the rotational force from the driving motor 320 in the first direction. The rotational force from the transmission 340 may be configured to cause the second spindle 370 and the first spindle 360 coupled to each other to rotate in the first direction. The transfer block 350 is configured such that the transfer block 350 moving in a forward direction toward the door 50 along a first thread 361 of the first spindle 360 opens the door. After the door is opened, the transmission 340 may be configured to move toward the driving motor 320 within the space of the bushing 330 resulting from the rotational force from the driving motor 320 in a second direction opposite to the first direction.

According to an embodiment, in the automatic mode of the door, the transmission 340 may be configured to first move toward the driving motor 320, and then rotate in a second direction resulting from the rotational force from the driving motor in the second direction. The rotational force from the transmission 340 may be configured to cause the second spindle 370 and the first spindle 360 coupled to each other to rotate in the second direction. The transfer block 350 may be configured such that the transfer block 350 moving in a rearward direction toward the driving motor 320 along a first thread 361 of the first spindle closes the door 50. After the door is closed, the transmission 340 may be configured to move toward the door 50 within the space of the bushing 330 resulting from the rotational force from the driving motor in a first direction opposite to the second direction.

A door driving module 300 according to an embodiment of the disclosure may include a driving motor 320 configured to generate rotational force, a transmission 340 configured to receive the rotational force from the driving motor, a bushing 330 configured with the driving motor 320 and the transmission 340 such that the rotational force generated from the driving motor 320 transmits to the transmission, and the transmission 340 is movable in a pace of the bushing 330 in a front-rear direction, a transfer block 350 configured to move in the front-rear direction in response to an opening operation or a closing operation of the door 50 in the automatic mode or the manual mode, a first spindle 360 configured to guide movement of a transfer block 350 in the front-rear direction such that the first spindle rotates in response to the opening operation or the closing operation of a door 50, and a second spindle 370 configured to guide the movement of the transmission 340 in the front-rear direction such that the second spindle 370, having a front end thereof coupled to the first spindle 360, rotates in conjunction with the rotation of the first spindle 360. In the automatic mode of the door, the transmission 340 may be configured to transmit the rotational force generated from the driving motor 320 to the second spindle 370. In the manual mode of the door, the transmission 340 may be configured to move in the front-rear direction within the space of the bushing 330 based on the rotational force received from the second spindle 370.

According to an embodiment, the first spindle 360 may include a first thread 361 arranged along an outer surface thereof, and the second spindle 370 may include a second thread 371 arranged along an inner surface thereof. A first length D1 along the first spindle, the first length being a distance by which a nut of the transfer block travels between the open state and the closed state in the front-rear direction, may be greater than a second length D2 along the second spindle 370, the second length being a distance by which a lead screw of the transmission 340 travels between the open state and the closed state in the front-rear direction.

According to an embodiment, a first thread 361 of the first spindle 360 has a first lead, and a second thread 371 of the second spindle 370 has a second lead smaller than the first lead, such that a linear movement distance of the transfer block 350 may be greater than a linear movement distance of the transmission 340.

According to an embodiment, in the manual mode of the door 50, the opening operation or the closing operation of the door 50 may be configured to be performed by an external force applied to the door 50 such that the transfer block 350 moving in the front-rear direction in response to the opening operation or the closing operation of the door 50 rotates the first spindle 360 and the second spindle 370 coupled to each other, thereby the transmission 340 moves within the space of the bushing 330.

According to an embodiment, in the automatic mode of the door 50, the rotational force transmitted from the driving motor 320 through the transmission 340 may be configured to rotate the second spindle 370 and the first spindle 360 coupled to each other. The transfer block 350 moving in the front-rear direction along a first thread of the first spindle 360 may be configured to perform the opening operation or the closing operation of the door 50.

1. A home appliance comprising:
a main body having an open front;
a door rotatably connected to the main body; and
a door driving module configured to open or close the door in an automatic mode or a manual mode with respect to the main body, the door driving module including:
a driving motor,
a transmission,
a bushing coupled with the driving motor and the transmission such that the rotational force generated from the driving motor is transmitted to the transmission, the bushing defining a space in which the transmission is movable along a front-rear direction of the door driving module,
a transfer block configured to move along the front-rear direction based on an opening operation or a closing operation of the door in the automatic mode or the manual mode,
a first spindle configured to guide a movement of the transfer block along the front-rear direction and to rotate based on the opening operation or the closing operation of the door, and
a second spindle configured to guide a movement of the transmission along the front-rear direction such that the second spindle, having a front end coupled to the first spindle, rotates in conjunction with a rotation of the first spindle,
wherein, in the automatic mode of the door, the transmission is configured to transfer the rotational force received from the driving motor to the second spindle, and
wherein, in the manual mode of the door, the transmission is configured to move along the front-rear direction within the space of the bushing based on the rotational force received from the second spindle.

2. The home appliance of claim 1,
wherein the first spindle includes a first thread arranged along an outer surface thereof, and the second spindle includes a second thread arranged along an inner surface thereof, and
wherein a first length along the first spindle that includes the first thread is greater than a second length along the second spindle that includes the second thread.

3. The home appliance of claim 1,
wherein the first spindle includes a first thread and the second spindle includes a second thread, and
the first thread of the first spindle has a first lead, and the second thread of the second spindle has a second lead smaller than the first lead, such that a linear movement distance of the transfer block is greater than a linear movement distance of the transmission.

4. The home appliance of claim 1,
wherein the bushing, the transmission, and the second spindle are configured to form a clutch structure, and
wherein the door driving module is configured to operate in:
a clutch engagement state in which the transmission is engaged with the second spindle so as to transfer power to the first spindle, and
a clutch disengagement state in which power transfer between the transmission and the second spindle is interrupted.

5. The home appliance of claim 4,
wherein, in the clutch engagement state, a front end of the transmission is disposed adjacent to a front end of an inner space of the second spindle, or a rear end of the transmission is disposed adjacent to a rear end of the space of the bushing, and
wherein the transmission is configured to rotate based on the rotational force received from the bushing such that the transmission rotates the second spindle.

6. The home appliance of claim 1,
wherein the first spindle includes a first thread and the second spindle includes a second thread, and
the first thread of the first spindle and the second thread of the second spindle are arranged to rotate in a first direction.

7. The home appliance of claim 1,
wherein, in a closed state of the door, the transmission is located closer to the door within the space of the bushing, and
wherein, in an open state of the door, the transmission is located closer to the driving motor within the space of the bushing.

8. The home appliance of claim 1,
wherein the first spindle includes a first thread and the second spindle includes a second thread, and
the first thread of the first spindle is arranged to rotate along a first direction, and the second thread of the second spindle is arranged to rotate in a second direction opposite to the first direction.

9. The home appliance of claim 8,
wherein, in a closed state of the door, the transmission is located closer to the driving motor within the space of the bushing, and
wherein, in an open state of the door, the transmission is located closer to the door within the space of the bushing.

10. The home appliance of claim 1,
wherein, in the manual mode of the door, the opening operation or the closing operation of the door is configured such that the transfer block moves along the front-rear direction based on the opening operation or the closing operation of the door by a force externally applied to the door, and thereby rotates the first spindle and the second spindle coupled to each other, and
the transmission is configured to move in the front-rear direction within the space of the bushing.

11. The home appliance of claim 1,
wherein, in the automatic mode of the door, the driving motor is configured to transmit the rotational force generated from the driving motor through the transmission to the second spindle and the first spindle such that the second spindle and the first spindle are interlocked with each other and rotate, and
the transfer block is configured to move along the front-rear direction along a first thread that is included on the first spindle which performs the opening operation or the closing operation of the door.

12. The home appliance of claim 1,
wherein, in the manual mode of the door, the transfer block is configured to move along a forward direction toward the door based on the opening operation of the door by a force externally applied to the door such that the transfer block rotates the first spindle and the second spindle interlocked with each other, along a first direction, and
the transmission is configured to move toward the driving motor within the space of the bushing.

13. The home appliance of claim 1,
wherein, in the manual mode of the door, the transfer block is configured to move in a rearward direction toward the driving motor based on the closing operation of the door by a force externally applied to the door such that the transfer block rotates the first spindle and the second spindle that are interlocked with each other, along a second direction opposite to a first direction, and
the transmission is configured to move toward the door within the space of the bushing.

14. The home appliance of claim 1,
wherein, in the automatic mode of the door, the transmission is configured to first move toward the door, and then rotate along a first direction resulting from the rotational force from the driving motor along the first direction,
the rotational force from the transmission is configured to cause the second spindle and the first spindle, which are interlocked with each other to rotate in the first direction,
the transfer block is configured such that the transfer block moving along a forward direction toward the door along a first thread of the first spindle opens the door, and
after the door is opened, the transmission is configured to move toward the driving motor within the space of the bushing resulting from the rotational force from the driving motor in a second direction opposite to the first direction.

15. The home appliance of claim 1,
wherein, in the automatic mode of the door, the transmission is configured to first move toward the driving motor, and then rotate in a second direction resulting from the rotational force from the driving motor in the second direction,
the rotational force from the transmission is configured to cause the second spindle and the first spindle coupled to each other to rotate in the second direction,
the transfer block is configured such that the transfer block moving in a rearward direction toward the driving motor along a first thread of the first spindle closes the door, and
after the door is closed, the transmission is configured to move toward the door within the space of the bushing resulting from the rotational force from the driving motor in a first direction opposite to the second direction.

16. A door driving module comprising:
a driving motor;
a transmission;
a bushing coupled with the driving motor and the transmission such that the rotational force generated from the driving motor is transmitted to the transmission, the bushing defining a space in which the transmission is movable along a front-rear direction of the door driving module;
a transfer block configured to move along the front-rear direction based on an opening operation or a closing operation of the door in the automatic mode or the manual mode;
a first spindle configured to guide a movement of a transfer block along the front-rear direction and to rotate based on an opening operation or a closing operation of a door; and
a second spindle configured to guide a movement of the transmission along the front-rear direction such that the second spindle, having a front end thereof coupled to the first spindle, rotates in conjunction with a rotation of the first spindle
wherein, in an automatic mode of the door, the transmission is configured to transfer the rotational force generated from the driving motor to the second spindle, and
wherein, in a manual mode of the door, the transmission is configured to move along the front-rear direction within the space of the bushing based on the rotational force received from the second spindle.

17. The door driving module of claim 16,
wherein the first spindle includes a first thread arranged along an outer surface thereof, and the second spindle includes a second thread arranged along an inner surface thereof, and
wherein a first length along the first spindle that includes the first thread is greater than a second length along the second spindle.

18. The door driving module of claim 16,
wherein the first spindle includes a first thread and the second spindle includes a second thread, and
the first thread of the first spindle has a first lead, and the second thread of the second spindle has a second lead smaller than the first lead, such that a linear movement distance of the transfer block is greater than a linear movement distance of the transmission.

19. The door driving module of claim 16,
wherein, in the manual mode of the door,
the opening operation or the closing operation of the door is configured to be performed by a force externally applied to the door such that the transfer block moves along the front-rear direction based on the opening operation or the closing operation of the door, rotates the first spindle and the second spindle), which are interlocked with each other, and thereby the transmission moves within the space of the bushing.

20. The door driving module of claim 16,
wherein, in the automatic mode of the door,
the rotational force transmitted from the driving motor through the transmission is configured to rotate the second spindle and the first spindle, which are interlocked with each other, and the transfer block moving along the front-rear direction along a first thread of the first spindle performs the opening operation or the closing operation of the door.
